(19) United States
(12) Patent Application Publication
(10) Pub. No.: US 2026/0032535 A1
(43) Pub. Date: Jan. 29, 2026

(54) DEVICE, METHOD AND MEDIUM FOR HANDOVER IN A HIERARCHICAL FEDERATED LEARNING NETWORK

(71) Applicant: Sony Group Corporation, Tokyo (JP)

(72) Inventors: Ce ZHENG, Beijing (CN); Chen SUN, Beijing (CN)

(73) Assignee: Sony Group Corporation, Tokyo (JP)

(21) Appl. No.: 19/099,083

(22) PCT Filed: Aug. 1, 2023
(86) PCT No.: PCT/CN2023/110473

§ 371 Date: Jan. 28, 2025

(30) Foreign Application Priority Data
Aug. 5, 2022 (CN) 202210936728.X

(51) Int. Cl. H04W 36/00; H04W 36/36; H04W 88/04

(52) U.S. Cl. CPC H04W 36/00837; H04W 36/362; H04W 88/04

(57) ABSTRACT

The present disclosure relates to device, method and medium for handover in a hierarchical federated learning network. An electronic device for federated learning at a network, comprising processing circuitry configured to: determine a model aggregation time and a remaining service time for a user equipment, wherein the user equipment is directly connected to the network or indirectly connected to the network via an intermediate node; make a handover decision for the user equipment in a case where the model aggregation time and the remaining service time meet a predefined condition; and transmit the handover decision for the user equipment.

### CROSS REFERENCE TO RELATED APPLICATIONS

The present application claims the benefit of Chinese patent application No.202210936728.X, entitled “HANDOVER IN A HIERARCHICAL FEDERATED LEARNING NETWORK”, filed on Aug. 5, 2022, the entirety of which is incorporated herein by reference.

### FIELD OF THE INVENTION

The present disclosure relates to device, method and medium for handover in a hierarchical federated learning network.

### RELATED ARTS

In a federated learning network, each user equipment (UE) accesses a base station through a wireless channel, and uploads a locally learned model to a server via the base station, and after aggregation, the server distributes an aggregated model to each user equipment via the base station. However, due to mobility of the user equipment, changes in the wireless channel between the user equipment and the base station, or the like, the user equipment may need to perform handover when carrying out the federated learning task.

### SUMMARY OF THE INVENTION

The present disclosure provides device, method and medium for handover in a hierarchical federated learning network.

According to an aspect of the present disclosure, there is provided an electronic device for federated learning at a network, comprising processing circuitry configured to: determine a model aggregation time and a remaining service time for a user equipment, wherein the user equipment is directly connected to the network or indirectly connected to the network via an intermediate node; make a handover decision for the user equipment in a case where the model aggregation time and the remaining service time meet a predefined condition; and transmit the handover decision for the user equipment.

According to another aspect of the present disclosure, there is provided an electronic device for federated learning at an intermediate node, comprising processing circuitry configured to: receive a handover decision for a user equipment from a network, wherein the handover decision is made in a case where a model aggregation time and a remaining service time for the user equipment meet a predefined condition, and the user equipment is indirectly connected to the network via the intermediate node; and transmit the handover decision to the user equipment.

According to yet another aspect of the present disclosure, there is provided an electronic device for federated learning at a user equipment, comprising processing circuitry configured to: receive a handover decision for the user equipment from a network, wherein the handover decision is made in a case where a model aggregation time and a remaining service time for the user equipment meet a predefined condition, and the user equipment is directly connected to the network or indirectly connected to the network via an intermediate node; and perform handover based on the handover decision.

According to yet another aspect of the present disclosure, there is provided a method for federated learning at a network, comprising: determining a model aggregation time and a remaining service time for a user equipment, wherein the user equipment is directly connected to the network or indirectly connected to the network via an intermediate node; making a handover decision for the user equipment in a case where the model aggregation time and the remaining service time meet a predefined condition; and transmitting the handover decision for the user equipment.

According to yet another aspect of the present disclosure, there is provided a method for federated learning at an intermediate node, comprising: receiving a handover decision for a user equipment from a network, wherein the handover decision is made in a case where a model aggregation time and a remaining service time for the user equipment meet a predefined condition, and the user equipment is indirectly connected to the network via the intermediate node; and transmitting the handover decision to the user equipment.

According to yet another aspect of the present disclosure, there is provided a method for federated learning at a user equipment, comprising: receiving a handover decision for the user equipment from a network, wherein the handover decision is made in a case where a model aggregation time and a remaining service time for the user equipment meet a predefined condition, and the user equipment is directly connected to the network or indirectly connected to the network via an intermediate node; and performing handover based on the handover decision.

According to still another aspect of the present disclosure, there is provided a non-transitory computer readable storage medium storing program instructions thereon which, when executed by a processor, cause the processor to perform the method of the present disclosure.

According to still another aspect of the present disclosure, there is provided a computer program product comprising program instructions which, when executed by a processor, cause the processor to perform the method of the present disclosure.

### DESCRIPTION OF THE DRAWINGS

A better understanding of the present disclosure may be achieved by referring to a detailed description given hereinafter in connection with accompanying figures. The same or similar reference signs are used to indicate the same or similar components throughout the figures. The figures are included in the specification and form a part of the specification along with the following detailed descriptions, for further illustrating embodiments of the present disclosure and for explaining the theory and advantages of the present disclosure.

FIG. 1 illustrates an exemplary structure of a conventional federated learning network.

FIG. 2 illustrates an exemplary structure of a hierarchical federated learning network according to an embodiment of the present disclosure.

FIG. 3 illustrates an exemplary federated learning process for a hierarchical federated learning network according to an embodiment of the present disclosure.

FIGS. 4A to 4C illustrate different handover scenarios for a local UE.

FIG. 5 illustrates an exemplary handover flow for a local UE according to an embodiment of the present disclosure.

FIGS. 6A to 6E illustrate cases where a remaining service time for a local UE meets different conditions.

FIG. 7 illustrates an exemplary handover flow for a global UE according to an embodiment of the present disclosure.

FIGS. 8A to 8C illustrate cases where a remaining service time for a global UE meets different conditions.

FIG. 9 illustrates an 5G core network SBA architecture and some of its network functions (NF).

FIG. 10 is a block diagram showing an example of a schematic configuration of a computing device in which techniques of the present disclosure may be applied.

FIG. 11 is a block diagram showing a first example of schematic configuration of a gNB in which techniques of the present disclosure may be applied;

FIG. 12 is a block diagram showing a second example of schematic configuration of a gNB in which techniques of the present disclosure may be applied;

FIG. 13 is a block diagram showing an example of schematic configuration of a smart phone in which techniques of the present disclosure may be applied; and

FIG. 14 is a block diagram showing an example of schematic configuration of an automobile navigation device in which techniques of the present disclosure may be applied.

### DESCRIPTION OF EMBODIMENTS

Hereinafter, preferred embodiments of the present disclosure will be described in detail with reference to the figures. Note that structural elements having substantially the same functions and structures are denoted with the same reference sign, and repeated explanations of these structural elements are omitted.

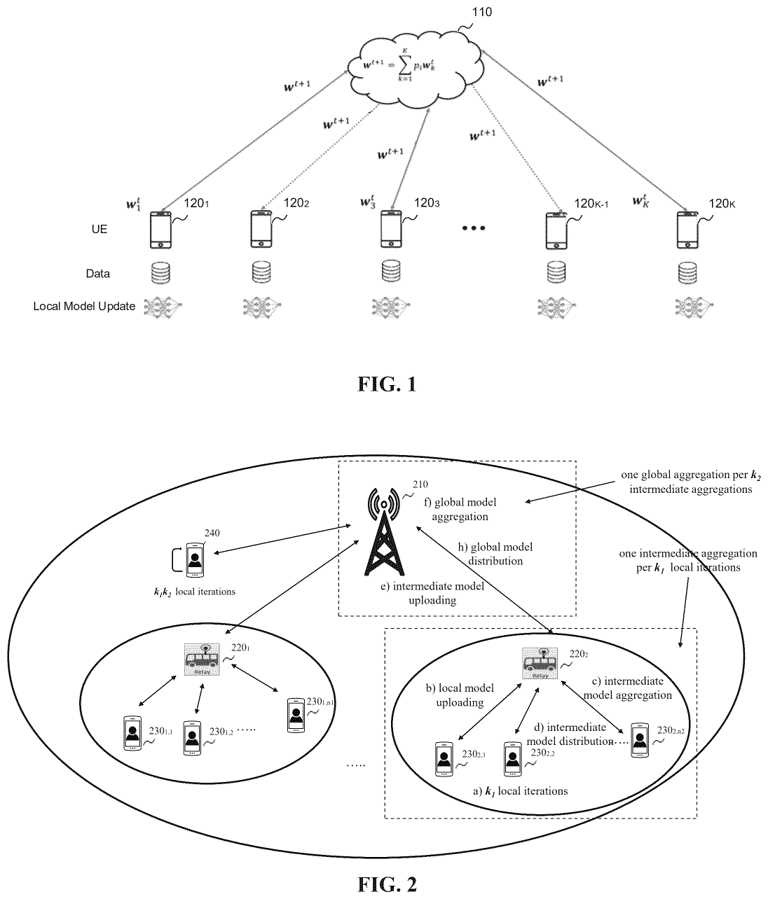

FIG. 1 illustrates an exemplary structure of a conventional federated learning network. In the conventional federated learning network, UEs 120₁, 120₂, 120₃ . . . 120_{K-1}, 120_{K} are directly connected to a server 110 via a base station (not shown), and upload local models to the server 110 for global aggregation. The detailed process is as follows.

First, the UEs 120 access the server 110, and obtain an initial global model w⁰ via downlink transmission:

$${w}_{1}^{0} = {w}_{2}^{0} = … = {w}_{K}^{0} = {w}^{0} ,$$

where

$${w}_{k}^{0}$$

represents an initial local model for the k-th UE.

The UEs 120 then learn using locally stored data, and completes the (r+1)-th local iteration of local model update:

$$\begin{matrix}{w}_{k}^{r + 1} = {w}_{k}^{r} - η \cdot {ℊ}_{k}^{r} , \\ {ℊ}_{k}^{r} = ∇ {F}_{k} ( {w}_{k}^{r} ) ,\end{matrix}$$

where

$${w}_{k}^{r}$$

represents a local moder for tie k-th UE after the r-th iteration,

$${ℊ}_{k}^{r}$$

represents gradients of the k-th UE, η represents a Learning Rate, and

$${F}_{k} ( {w}_{k}^{r} )$$

represents a loss function for the k-th UE.

The UEs 120 then upload the learned local model

$$( {w}_{k}^{r + 1} )$$

or gradients

$$( {ℊ}_{k}^{t} )$$

to the server 110 via an uplink. The server 110 aggregates the collected local models from the UEs, and completes an update of the global model:

$${w}^{r + 1} = {\sum }_{i = 1}^{K} {p}_{k} {w}_{k}^{r + 1} ,$$

where pₖ is a weight for the local model from each UE, and is usually set to

$${p}_{k} = \frac{\vert {D}_{k} \vert}{{\sum }_{i = 1}^{K} \vert {D}_{i} \vert} ,$$

Dᵢ represents a dataset of the i-th UE, and |Dᵢ| represents a size of the dataset.

Finally, the server 110 redistributes the updated global model w^{r+1} to the UEs 120, and then the above steps are repeated until the model is converged.

However, such network structure has its corresponding limitations. First, the base station has a limited coverage, and cannot provide service to UEs out of the coverage. Secondly, there are some areas with a low communication rate in the coverage of the base station, and service quality for the UE in the area, even within the coverage, cannot be guaranteed. Additionally, uplink and downlink communication resources (such as frequency resources, the number of carriers, etc.) of the base station are limited, and simultaneous access cannot be supported for too many UEs.

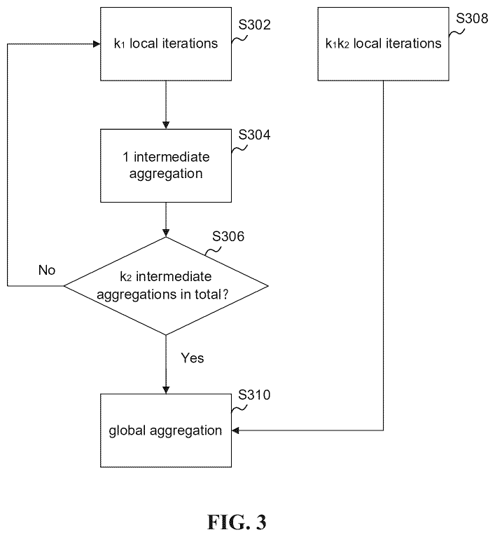

FIG. 2 illustrates an exemplary structure of a hierarchical federated learning network according to embodiments of the present disclosure. The network structure consists of two layers: the first layer is composed of intermediate nodes 220 and their served UEs 230 (a UE connected to the intermediate node is referred to herein as a local UE); and the second layer is composed of a global node 210, the intermediate nodes 220 connected thereto, and UEs 240 directly connected to the global node (a UE directly connected to the global node is referred to herein as a global UE).

The global node is implemented by a base station and/or a server connected to the base station. The intermediate node may be a Vehicle Mounted Relay (VMR) with mobility, an Unmanned Aerial Vehicle (UAV), or the like. Alternatively, the intermediate node may be implemented as a fixed-location roadside units (RSU), an Edge node, or the like.

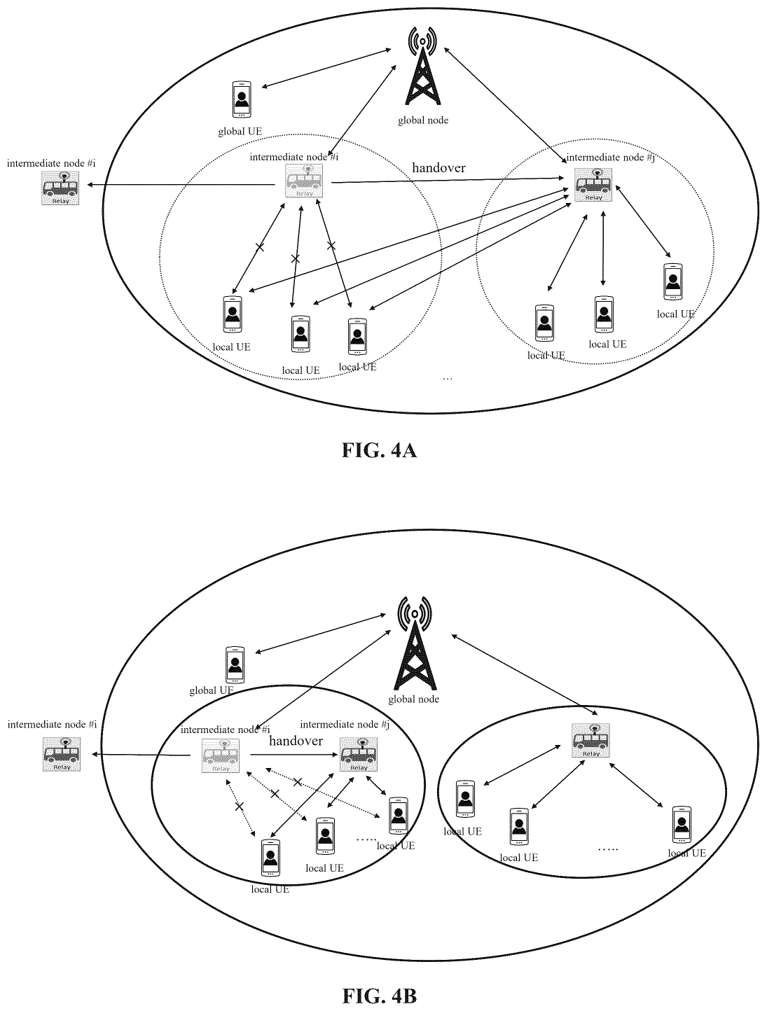

An exemplary federated learning process for the hierarchical federated learning network according to embodiments of the present disclosure is described below in connection with FIG. 3.

In step S302, the local UE 230 (as a first-level node) performs, for example, k₁ local iterations, and uploads the resulting local model to the intermediate node 220 (as a second-level node) for intermediate aggregation. In step S304, the intermediate node 220 performs one intermediate aggregation on the local models received from the local UEs 230, to obtain an intermediate model.

In step S306, the intermediate node 220 determines whether a total of, for example, k₂ intermediate aggregations are completed. If the total number of the intermediate aggregations is less than k₂, the intermediate node 220 distributes the intermediate model to the local UEs 230. The local UE 230 updates its local model to the intermediate model after receiving the intermediate model and performs a new round of local iterations. If the total number of the intermediate aggregations has reached k₂, the intermediate node 220 uploads the intermediate model to the global node 210 for global aggregation.

In step S308, if there are global UEs 240 directly served by the global node 210, the global UE 240 performs, for example, k₁k₂ local iterations, and uploads the resulting local model to the global node 210.

In step S310, the global node 210 (or a network device connected thereto, such as a server) performs global aggregation on the intermediate models uploaded by the intermediate nodes 220 and the local models uploaded by the global UEs 240 (if any), and distributes the resulting global model to the intermediate nodes 220 and the global UEs 240 (if any). The intermediate node 220, after receiving the global model, updates its intermediate model to the global model and distributes the global model to the local UEs 230 it serves. The local UEs 230 and the global UEs 240 update the local models to the global model after receiving the global model.

In the hierarchical federated learning network structure of the embodiments of the disclosure, the local UE is connected to the intermediate node, so that the communication distance is shortened and the communication service quality is guaranteed. In addition, a plurality of local UEs communicate directly with the intermediate node which in turn is connected to the global node. Although the intermediate node serves the plurality of local UEs, each communication between it and the global node only uploads the aggregated intermediate model. The amount of data corresponds to that in the communication between one global UE and the global node or in the communication between one local UE and the intermediate node. The load of the global node is greatly reduced, and the problem of insufficient communication resources at the global node is relieved. In addition, such network structure takes full advantage of functions of the intermediate node, that is, the intermediate node not only carries out transmission as a relay to, but also participates in calculation as an aggregator at the first-layer structure, and completes the intermediate aggregation of the models.

The specific federated learning process in the local UEs, the intermediate nodes, the global UEs, and the global node according to embodiments of the present disclosure will be described in detail below. Assuming that there are C global UEs, M intermediate nodes, and the number of local UEs served by the i-th intermediate node is nᵢ. In the federated learning process, the UE and the intermediate node can upload a federated learning model by uploading model parameters or gradients. Therefore, the federated learning processes by uploading the model parameters and by uploading the gradients will be described below, respectively.

The federated learning process by uploading the model parameters is introduced at first. The global node first initializes a global model w⁰, and distributes the initialized global model to the global UEs and the intermediate nodes. Then, the intermediate node distributes the initialized global model to the local UEs. At this moment, the global node, the global UEs, the intermediate nodes and the local UEs have the same federated learning model:

$${w}_{i}^{0} = {w}_{i , 1}^{0} = … = {w}_{i , l}^{0} = … = {w}_{i , {n}_{i}}^{0} = {w}^{0} , \qquad ( 1 )$$

where:

$${w}_{i ,}^{0}$$

—model parameters of the intermediate node #i,

$${w}_{i , l}^{0}$$

—model parameters of the l-th local UE served by the intermediate node #i,
nᵢ—the number of local UEs served by the intermediate node #i.

Each local UE performs local iteration based on locally stored data:

$$\begin{matrix}{w}_{i , l}^{{r}_{1} + 1} ← {w}_{i , l}^{{r}_{1}} - η \cdot {ℊ}_{i , l}^{{r}_{1}} , \\ {ℊ}_{i , l}^{{r}_{1}} = ∇ {F}_{i , l} ( {w}_{i , l}^{{r}_{1}} ) , \\ {r}_{1} = 0 , 1 , 2 , … ,\end{matrix} \qquad ( 2 )$$

where,

$${w}_{i , l}^{{r}_{1} + 1}$$

—local model parameters of the l-th local UE served by the intermediate node #i after the (r₁+1)-th local iteration,

$${w}_{i , l}^{{r}_{1}}$$

—local model parameters of the the l-th local UE served by the intermediate node #i after the r₁-th local iteration,

$${g}_{i , l}^{{r}_{1}}$$

—local gradients of the l-th local UE served by the intermediate node #i at the (r₁+1)-th local iteration,

$${F}_{i , l} ( {w}_{i , l}^{{r}_{1}} )$$

—local loss function of the l-th local UE served by the intermediate node #i at the (r₁+1)-th local iteration.

The local UE obtains local model parameters

$${w}_{i , l}^{{r}_{1} + {k}_{1}}$$

after k₁ local iterations, and uploads them to the intermediate node. After receiving the local models uploaded by all of the served local UEs, the intermediate node performs one intermediate aggregation:

$${w}_{i}^{{r}_{2} + 1} = {\sum }_{l = 1}^{{n}_{i}} {p}_{i , l} {w}_{i , l}^{{r}_{1} + {k}_{1}} , \qquad ( 3 )$$

$${r}_{2} = 0 , 1 , 2 , … ,$$

$${r}_{1} = {k}_{1} {r}_{2} ,$$

where,

$${w}_{i}^{{r}_{2} + 1}$$

—intermediate model parameters of the intermediate node #i after the (r₂+1)-th intermediate aggregation,

$${w}_{i}^{{r}_{2}}$$

—intermediate model parameters of the intermediate node #i after the r₂-th intermediate aggregation,
p_{i,l}—weight corresponding to the local model uploaded by the l-th local UE served by the intermediate node #i, which is usually determined by using the last intermediate model as a reference,
r₁=k₁r₂, that is, each time the intermediate node completes one intermediate aggregation, the local UE served by the intermediate node completes k₁ local model updates.

The intermediate node then distributes the model resulting from the intermediate aggregation (referred to herein as intermediate model) to the local UEs served by it.

The process of Equations (2) and (3) is repeated. When r₂ is not an integer multiple of k₂, the intermediate node distributes the model after intermediate aggregation to each of the local UEs served by it. The local UE update the local model using the received intermediate model. When r₂ is an integer multiple of k₂, the intermediate node uploads the resulting intermediate model to the global node after completing k₂ intermediate aggregations.

Further, in parallel to the process of Equations (2) and (3), the global UEs performs local iterations individually based on local data, which is similar to the process of Equation (2):

$${w}_{c , j}^{{r}_{1} + 1} ← {w}_{c , j}^{{r}_{1}} - η \cdot {g}_{c , j}^{{r}_{1}} , \qquad ( 4 )$$

$${g}_{c , j}^{{r}_{1}} = ∇ {F}_{c , j} ( {w}_{c , j}^{{r}_{1}} ) ,$$

where,

$${w}_{c , j}^{{r}_{1} + 1}$$

—local model parameters of the j-th global UE after the (r₁+1)-th local iteration,

$${w}_{c , j}^{{r}_{1}}$$

—local model parameters of the j-th global UE after the r₁-th local iteration,

$${g}_{c , j}^{{r}_{1}}$$

—local gradient of the j-th global UE after the (r₁+1)-th local iteration,

$${F}_{c , j} ( {w}_{c , j}^{{r}_{1}} )$$

—local loss function of the j-th global UE after the (r₁+1)-th local iteration.

The global UE obtains local model parameters

$${w}_{c}^{{r}_{1 + {k}_{1} {k}_{2}}}$$

after k₁k₂ local iterations, and uploads them to the global node.

After receiving the intermediate models uploaded by all intermediate nodes and the local models uploaded by all global UEs, the global node performs the global aggregation:

$${w}^{{r}_{3} + 1} = {\sum }_{i = 1}^{M} {p}_{i} {w}_{i}^{{r}_{2} + {k}_{2}} + {\sum }_{j = 1}^{C} {p}_{c , j} {w}_{c , j}^{{r}_{1 + {k}_{1} {k}_{2}}} , \qquad ( 5 )$$

$${\sum }_{i = 1}^{M} {p}_{i} + {\sum }_{j = 1}^{C} {p}_{c , j} = 1 ,$$

where,
w^{r}^{₃}⁺¹—global model parameters of the global node after the (r₃+1)-th global aggregation,

$${w}_{i}^{{r}_{2} + {k}_{2}}$$

—intermediate model parameters uploaded by the i-th intermediate node,

$${w}_{c , j}^{{r}_{1} + {k}_{1} {k}_{2}}$$

—local model parameters uploaded by the j-th global UE,
pᵢ—weight corresponding to the intermediate model uploaded by the i-th intermediate node, which is usually determined using the last global model as a reference,
p_{c,j}—weight corresponding to the local model uploaded by the j-th global UE, which is usually determined using the last global model as a reference,
r₂=k₂r₃, that is, each time the global node completes one global aggregation, the intermediate node connected to the global node completes k₂ intermediate aggregations.

The global node performs the global model aggregation to obtain global model parameters w^{r}^{₃}⁺¹, and distributes them to the intermediate nodes and the global UEs.

The process of Equations (2) to (5) is repeated until the global model is converged.

Next, the federated learning process in which the UEs and the intermediate nodes upload gradients is described. First, the global node initializes and distributes the global model to the global UEs and the intermediate nodes. The intermediate node then distributes the initialized global model to the local UEs. At this moment, the global node, the global UEs, the intermediate nodes, and the local UEs have the same learning model:

$${w}_{i}^{0} = {w}_{i , 1}^{0} = … = {w}_{i , l}^{0} = … = {w}_{i , {n}_{i}}^{0} = {w}^{0} , \qquad ( 6 )$$

where,

$${w}_{i}^{0}$$

—local model parameters of the intermediate node #i,

$${w}_{i , l}^{0}$$

—local model parameters of the l-th UE served by the intermediate node #i,
nᵢ—the number of local UEs served by the intermediate node #i.

Each of the local UEs performs local iteration based on locally stored data:

$${w}_{i , l}^{{r}_{1} + 1} ← {w}_{i , l}^{{r}_{1}} - η \cdot {g}_{i , l}^{{r}_{1}} , \qquad ( 7 )$$

$${g}_{i , l}^{{r}_{1}} = ∇ {F}_{i , l} ( {w}_{i , l}^{{r}_{1}} ) ,$$

$${r}_{1} = 0 , 1 , 2 , ... ,$$

where,

$${w}_{i , l}^{{r}_{1} + 1}$$

—local model parameters of the l-th local UE served by the intermediate node #i after the (r₁+1)-th local iteration,

$${w}_{i , l}^{{r}_{1}}$$

—local model parameters of the l-th local UE served by the intermediate node #i after the r₁-th local iteration,

$${g}_{i , l}^{{r}_{1}}$$

—local gradients of the l-th local UE served by the intermediate node #i at the (r₁+1)-th local iteration,

$${F}_{i , l} ( {w}_{i , l}^{{r}_{1}} )$$

—local loss function of the l-th local UE served by the intermediate node #i at the (r₁+1)-th local iteration.

The local UE obtains local model parameters

$${w}_{i , l}^{{r}_{1} + {k}_{1}}$$

after k₁ local iterations, and calculates a sum

$${\tilde{g}}_{i , l}^{{t}_{2}}$$

of gradients of the k₁ local iterations:

$${w}_{i , l}^{{r}_{1} + {k}_{1}} ← {w}_{i , l}^{{r}_{1}} - η \cdot {\sum }_{τ = 0}^{{k}_{1} - 1} {p}_{i , l} {g}_{i , l}^{{r}_{1} + τ} , \qquad ( 8 )$$

$${\tilde{g}}_{i , l}^{{r}_{2}} = {\sum }_{τ = 0}^{{k}_{1} - 1} {g}_{i , l}^{{r}_{1} + τ} ,$$

The local UE uploads the gradient

$${\tilde{g}}_{i , l}^{{r}_{2}}$$

to the intermediate node. After receiving the local gradients uploaded by all of the served local UEs, the intermediate node performs one intermediate aggregation:

$${w}_{i}^{{r}_{2} + 1} = {w}_{i}^{{r}_{2}} - η \cdot {\sum }_{l = 1}^{{n}_{i}} {p}_{i , l} {\tilde{g}}_{i , l}^{{r}_{2}} , \qquad ( 9 )$$

$${\tilde{g}}_{i}^{{r}_{2}} = {\sum }_{l = 1}^{{n}_{i}} {p}_{i , l} {\tilde{g}}_{i , l}^{{r}_{2}} ,$$

$${r}_{2} = 0 , 1 , 2 , ... ,$$

where,

$${w}_{i}^{{r}_{2} + 1}$$

—intermediate model parameters of the intermediate node #i after the (r₂+1)-th intermediate aggregation,

$${w}_{i}^{{r}_{2}}$$

—intermediate model parameters of the intermediate node #i after the r₂-th intermediate aggregation,

$${\tilde{g}}_{i}^{{r}_{2}}$$

—gradients of the intermediate node #i at the (r₂+1)-th intermediate aggregation,
p_{i,l}—weight corresponding to the local model (gradient) uploaded by the I-th local UE served by the intermediate node #i,
r₁=k₁r₂, that is, each time the intermediate node completes one intermediate aggregation, the local UE served by the intermediate node completes k₁ local model updates.

The process of Equations (7) to (9) is repeated. When r₂ is not an integer multiple of k₂, the intermediate node distributes the model after intermediate aggregation (referred to herein as intermediate model) to the local UEs served by it. The local UE updates its local model with the received intermediate model. When r₂ is an integer multiple of k₂, the intermediate node uploads the resulting intermediate model to the global node after completing k₂ intermediate aggregations.

The intermediate node obtains intermediate model parameters

$${w}_{i}^{{r}_{2} + {k}_{2}}$$

after k₂ intermediate aggregations, and calculates a sum

$${\tilde{G}}_{i}^{{r}_{3}}$$

of gradients of the k₂ intermediate aggregations:

$${w}_{i}^{{r}_{2} + {k}_{2}} ← {w}_{i}^{{r}_{2}} - η \cdot {\sum }_{τ = 0}^{{k}_{2} - 1} {\tilde{g}}_{i}^{{r}_{2 +} τ} \\ {\tilde{G}}_{i}^{{r}_{3}} = {\sum }_{τ = 0}^{{k}_{2} - 1} {\tilde{g}}_{i}^{{r}_{2 +} τ} \qquad ( 10 )$$

The intermediate node uploads the gradient

$${\tilde{G}}_{i}^{{r}_{3}}$$

to the global node for global aggregation.

Further, in parallel to the process of Equations (7) to (10), the global UEs perform local iterations individually based on local data, which is similar to the process of Equation (7):

$${w}_{c , j}^{{r}_{1} + 1} ← {w}_{c , j}^{{r}_{1}} - η \cdot {g}_{c , j}^{{r}_{1}} , \\ {g}_{c , j}^{{r}_{1}} = ∇ {F}_{c , j} ( {w}_{c , j}^{{r}_{1}} ) , \qquad ( 11 )$$

where,

$${w}_{c , j}^{{r}_{1} + 1}$$

—local model parameters of the j-th global UE after the (r₁+1)-th model update,

$${w}_{c , j}^{{r}_{1}}$$

—local model parameters of the j-th global UE before the r₁-th model update,

$${g}_{c , j}^{{r}_{1}}$$

—local gradients of the j-th global UE at the r₁-th model update,

$${F}_{c , j} ( {w}_{c , j}^{{r}_{1}} )$$

—local loss function of the j-th global UE at the r₁-th model update,
and the global UE obtains local model parameters

$${w}_{c , j}^{{r}_{1} + {k}_{1} {k}_{2}}$$

after k₁k₂ local iterations, and uploads the gradient

$${\tilde{g}}_{c , j}^{{r}_{3}}$$

to the global node:

$${w}_{c , j}^{{r}_{1} + {k}_{1} {k}_{2}} ← {w}_{c , j}^{{r}_{1}} - η \cdot {\sum }_{τ = 0}^{{k}_{1} {k}_{2} - 1} {p}_{c , j} {g}_{c , j}^{{r}_{1} + τ} , \\ {\tilde{g}}_{c , j}^{{r}_{3}} = {\sum }_{τ = 0}^{{k}_{1} {k}_{2} - 1} {g}_{c , j}^{{r}_{1} + τ} , \qquad ( 12 )$$

and after receiving the intermediate models uploaded by all intermediate nodes and the local models uploaded by all global UEs, the global node perform global aggregation:

$$\begin{matrix}{w}^{{r}_{3} + 1} = {w}^{{r}_{3}} - η \cdot ( {\sum }_{i = 1}^{M} {p}_{i} {\tilde{G}}_{i}^{{r}_{3}} + {\sum }_{j = 1}^{C} {p}_{c , j} {\tilde{g}}_{c , j}^{{r}_{3}} ) , \\ {g}^{{r}_{3}} = {\sum }_{i = 1}^{M} {p}_{i} {\tilde{G}}_{i}^{{r}_{3}} + {\sum }_{j = 1}^{C} {p}_{c , j} {\tilde{g}}_{c , j}^{{r}_{3}} , \\ {\sum }_{i = 1}^{M} {p}_{i} + {\sum }_{j = 1}^{C} {p}_{c , j} = 1 ,\end{matrix} \qquad ( 13 )$$

where,
w^{r}^{₃}⁺¹—global model parameters of the global node after the (r₃+1)-th global aggregation,

$${\tilde{G}}_{i}^{{r}_{3}}$$

—intermediate model gradient uploaded by the i-th intermediate node,

$${\tilde{g}}_{c , j}^{{r}_{3}}$$

—local model gradient uploaded by the j-th global UE,
pᵢ—weight corresponding to the intermediate model uploaded by the i-th intermediate node,
p_{c,j}—weight corresponding to the local model uploaded by the j-th global UE,
r₃=k₁k₂r₁, that is, each time the global node completes one global aggregation, the intermediate node connected thereto completes k₂ intermediate aggregations.

The global node performs global model aggregation update, and distributes the aggregated model to the intermediate nodes and the global UEs.

The process of Equations (7) to (13) is repeated until the global model is converged.

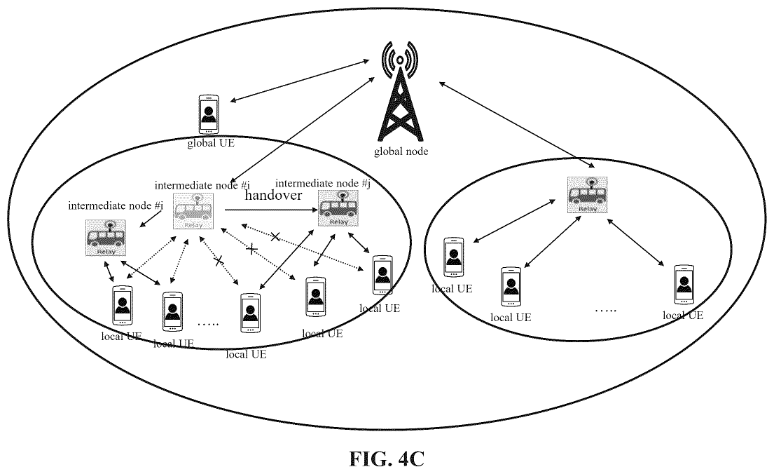

Due to mobility of the UEs and the intermediate nodes, changes in wireless channels, or the like, the UE may need handover while performing the federated learning task. FIG. 4A illustrates a scenario in which one or more local UEs are handed over from the intermediate node #i to the intermediate node #j, and prior to the handover, the intermediate node #j is serving local UEs. In this scenario, there is an intermediate model at the intermediate node #j, so there is no need to transfer the intermediate model from the intermediate node #i to the intermediate node #j.

Without considering the federated learning, UE #l performs handover directly when a handover condition is met (e.g., received signal strength RSRP is less than a certain threshold). If the handover of the UE #l happens during the (r₂+1)-th intermediate aggregation at the intermediate node #i (the r₂-th intermediate aggregation has been completed but the (r₂+1)-th intermediate aggregation has not been completed, i.c., k₁r₂<r₁<k₁(r₂+1)), the following result is caused.

First, for the intermediate node #i, it has disconnected with the UE #l, and cannot receive the local model of the UE #l when performing the (r₂+1)-th intermediate aggregation. Second, for the intermediate node #j, it may receive the local model uploaded by the UE #l. But the local model uploaded by the UE #l after the (r₁=k₁(r₂+1))-th local iteration is resulting from the training on the intermediate model received from the intermediate node #i (instead of the intermediate node #j) at r₁=k₁r₂.

One existing solution is that the intermediate node #j discards and does not use the local model uploaded by the UE #l after the (r₁=k₁(r₂+1))-th local iteration. Thus, for the UE #l, only if it is completely within the coverage of corresponding intermediate node during the (r₂+1)-th intermediate aggregation of the intermediate node #i (or the intermediate node #j) (from the transmission of the model of the r₂-th intermediate aggregation to the UE #l, to the completion of the k₁(r₂+1)-th local iteration and uploading by the UE #l), it can participate in the (r₂+1)-th intermediate aggregation of this intermediate node.

Another existing solution is that the intermediate node #j uses the local model uploaded by the UE #l after the (r₁=k₁(r₂+1))-th local iteration for its (r₂+1)-th intermediate aggregation. But this may cause divergence of the intermediate model at the intermediate node #j, resulting in a degradation of system performance (e.g., global model convergence speed) or global model accuracy.

FIG. 4B illustrates a scenario where all local UEs served by the intermediate node #i are handed over to the intermediate node #j, and no local UEs are served by the intermediate node #j before the handover. This scenario may be caused by movement of the intermediate node #i, or by movement of the UE.

Assume that the UE is handed over from the intermediate node #i to the intermediate node #j after the r₂-th intermediate aggregation is completed. Then the intermediate node #j performs the (r₂+1)-th intermediate aggregation, which requires an intermediate model after the r₂-th intermediate aggregation. If the gradients are uploaded, as shown in the Equation (10), the intermediate model after the r₂-th intermediate aggregation is required to calculate the intermediate model after the (r₂+1)-th intermediate aggregation, but at this moment, the intermediate model after the r₂-th intermediate aggregation is not available at the intermediate node #j. Even if the model parameters are uploaded, parameters of the last intermediate model are required to determine the weights used in calculating the intermediate model.

In this scenario, there is no intermediate model at the intermediate node #j, but a global model initially received from the global node. Thus, the intermediate node #i needs to transfer its intermediate model to the intermediate node #j.

FIG. 4C illustrates a scenario where a part of the local UEs served by intermediate node #i is handed over to the intermediate node #j, and no local UEs are served by the intermediate node #j before the handover. Compared with before the handover, a part of the UEs is not involved in the intermediate aggregation at both of the intermediate node #i and the intermediate node #j after the handover, resulting in divergence of the model and reduction of the accuracy. Namely, when the handover happens during the intermediate aggregation, even the handover of only a part of the UEs may cause the divergence of the intermediate model, which reduces the accuracy of the global model.

In view of the above, some embodiments of the present disclosure enable a UE to perform handover after the global aggregation and broadcasting of the global model. At the moment, the models of the UEs and the intermediate nodes are the same and are the global model, and extra model transmission is not needed, which minimizes a cost of the handover. Some embodiments of the present disclosure enable the handover to be performed after the intermediate nodes have completed the intermediate aggregations, if the handover is not ensured to be performed after the global aggregation and broadcasting of the global model. At this moment, the model of an intermediate node is the same as those of all local UEs served by it, and uninterruption of the training service of the local UEs can be ensured. In addition, some embodiments of the present disclosure may also extend a connection time of the UE and/or the intermediate node until the the intermediate aggregation or the global aggregation is completed, by increasing a transmit power, decreasing a RSRP threshold, allocating more transmission resources (including time resources and frequency resources), or the like. Thus, continuity of the service is ensured, and the system performance is improved.

For simplicity of illustration, the following variables are first defined:
Tₛₑᵣᵥₑ—an estimated value of a remaining time for which the global or intermediate node is serving the UE;
T₁—an estimated value of a remaining time required for the global node to complete the current round of global aggregations, i.e., a time from the current moment to completion of the current round of global aggregations by the global node;
T₂—a time required for the global node to complete the next round of global aggregations, i.e., a time from completion of the current round of global aggregations by the global node to completion of the next round of global aggregations by the global node;
Tₜᵣₐᵢₙ—remaining time required for the global node to complete the current and next rounds of global aggregations, i.e., a time from the current moment to completion of the next round of global aggregations by the global node, i.e., Tₜᵣₐᵢₙ=T₁+T₂;
t₁—a remaining time required for the intermediate node to complete the current round of intermediate aggregations, i.e., a time from the current moment to completion of the current round of the intermediate node aggregations by the intermediate node;
t₂—a remaining time required for the intermediate node to complete the next round of intermediate aggregations, i.e., a time from completion of the current round of intermediate node aggregations by the intermediate node to completion of the next round of intermediate node aggregations by the intermediate node;
tₜᵣₐᵢₙ—a remaining time required for the intermediate node to complete the current and next rounds of global aggregations, i.e., a time from the current moment to completion of the next round of intermediate node aggregations by the intermediate node, i.e., tₜᵣₐᵢₙ=t₁+t₂.

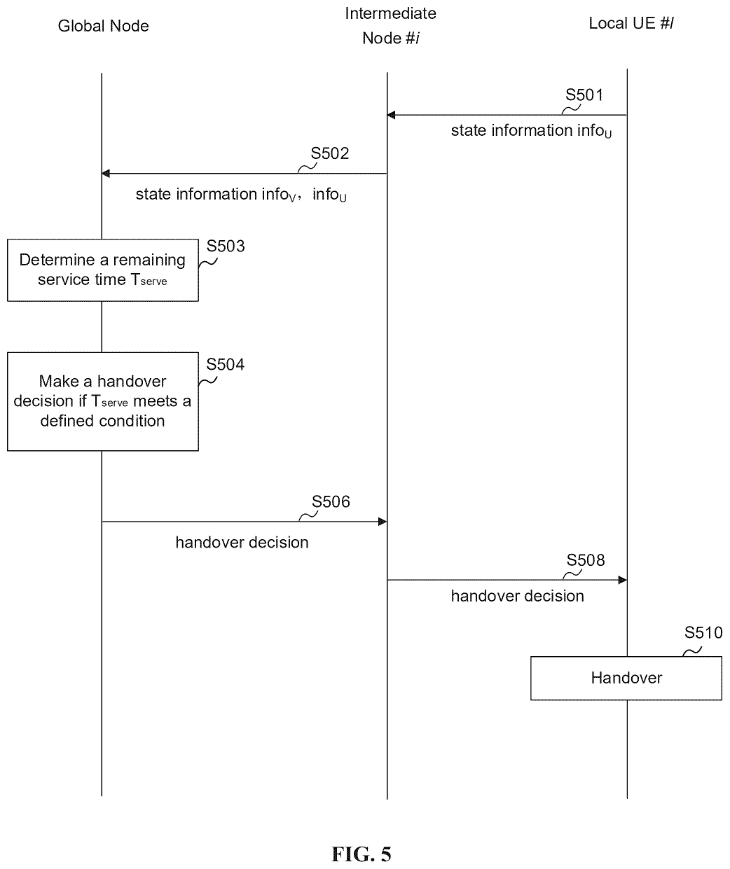

First, a case where UE #l is a local UE served by intermediate node #i is discussed, the UE #l may be handed over to be served by intermediate node #j or directly by a global node. FIG. 5 illustrates an exemplary handover process for a local UE according to an embodiment of the present disclosure.

In step S501, the UE #l transmits its own state information Info_{U} to the intermediate node #i. The state information Info_{U} of the UE may include one or more of channel state (e.g., RSRP), computing capability (e.g., CPU occupancy), local data information (e.g., number of samples involved in model training, sample dimensions, etc.), power, location and movement information (e.g., speed, direction, dwell time at a location, etc.), and the like.

In step S502, the intermediate node #i transmits its own state information Info_{V} and the state information Info_{U} of the local UEs served by it to the global node. The state information Info_{V} of the intermediate node may include one or more of channel state (RSRP), computing capability (e.g., CPU occupancy), location and movement information (e.g., speed, direction, dwell time at a location, etc.), and the like. The channel state of the intermediate node may include a channel state between the intermediate node and the local UE and a channel state between the intermediate node and the global node.

In step S503, the global node determines a remaining service time Tₛₑᵣᵥₑ for the UE #l, which is a remaining time for the intermediate node #i to serve this local UE. In step S504, the global node makes a handover decision in a case where Tₛₑᵣᵥₑ meets a predefined condition.

For estimation of Tₛₑᵣᵥₑ, it may be determined by the global node from the state information Info_{V} of the intermediate node #i and the state information Info_{U} of the UE #l. The global node may estimate a link quality and a connection time (e.g., a time when RSRP is greater than a certain threshold) between it and the intermediate node #i, and a link quality and a connection time (e.g., a time when RSRP is greater than a certain threshold) between the intermediate node #i and the UE #l, and then estimate the time Tₛₑᵣᵥₑ for which the intermediate node #i can serve the UE #l. For example, the global node may determine a time when the link between the global node and the intermediate node #i and the link between the intermediate node #i and the UE #l simultaneously satisfy respective requirements as the time Tₛₑᵣᵥₑ for which the intermediate node #i can serve the UE #l.

For estimations of T₁, T₂ and Tₜᵣₐᵢₙ, they may be determined by the global node from the state information Info_{U} of all UEs and the state information Info_{V} of all intermediate nodes. For estimations of t₁, t₂ and tₜᵣₐᵢₙ, they may be determined by the global node from the state information Info_{V} of the intermediate node #i and the state information Info_{U} of all local UEs served by the intermediate node #i. Alternatively, for estimations of t₁, t₂ and tₜᵣₐᵢₙ, they may be determined by the intermediate node #i from the state information Info_{V} of itself and the state information Info_{U} of all local UEs served by it, and transmitted to the global node in step S502.

For estimations of Tₛₑᵣᵥₑ, T₁, T₂, Tₜᵣₐᵢₙ, t₁, t₂, and tₜᵣₐᵢₙ, they may be performed periodically by the global node and the intermediate nodes, or may be triggered by some trigger event, such as sudden movement of an intermediate node or a UE.

In step S506, the global node transmits a handover decision to the intermediate node #i. In step S508, the intermediate node #i transmits the received handover decision to the UE #l. In step S510, the UE #l performs handover based on the received handover decision.

After making the handover decision, the global node may transmit the handover decision immediately, or may transmit it in broadcasting the global model after the global aggregation is over. In the hierarchical federated learning structure of Base station-VMR-UE, the handover decision is transmitted conventionally, that is, to the intermediate node #i via Uu link (Downlink), and then from the intermediate node #i to the UE #l via PC5 (Sidelink). The global model is transmitted by broadcast, and can be received by each of the intermediate nodes. However, the handover decision by the global node is not in the form of broadcast, but is transmitted to only the UE #l which needs to perform handover and the intermediate node #i connected thereto.

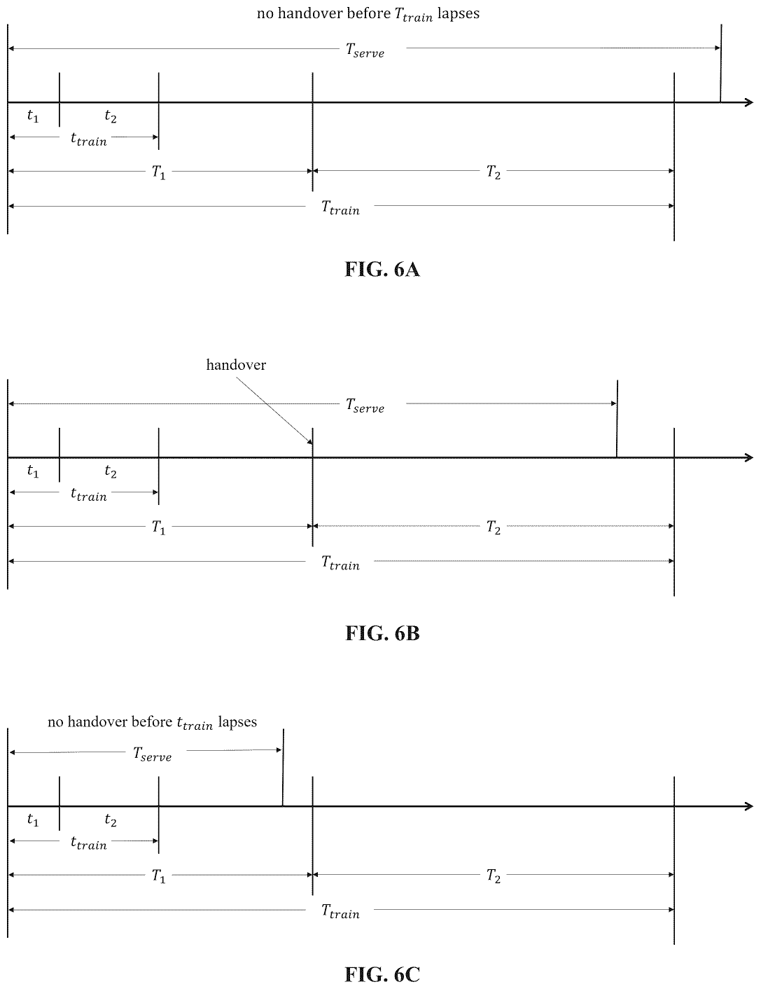

Next, discussions will be made on conditions that are met by Tₛₑᵣᵥₑ when the UE #l is a local UE, and on whether to make a handover decision under the conditions, with reference to FIGS. 6A-6E, respectively.

FIG. 6A illustrates a case of Tₛₑᵣᵥₑ>Tₜᵣₐᵢₙ when the UE #l is a local UE. In this case, the UE may participate in and complete the current and next rounds of global aggregations. Thus, the handover is not performed until Tₜᵣₐᵢₙ lapses.

FIG. 6B illustrates a case of T₁<Tₛₑᵣᵥₑ<Tₜᵣₐᵢₙ when the UE #l is a local UE. In this case, the UE may participate in and complete the current round of global aggregation, but its service time cannot support completion of the next round of global aggregations, and then the UE is handed over after the current round of global aggregations. The global node broadcasts and transmits the global model after the current round of global aggregations. At this moment, the UEs and the intermediate nodes have the same model, and the handover only needs to consider establishment and release of a communication link, with no need to consider transfer of the model, divergence of the intermediate model, and the like.

FIG. 6C illustrates a case of tₜᵣₐᵢₙ<Tₛₑᵣᵥₑ<T₁ when the UE #l is a local UE. In this case, the service provided by the original intermediate node #i to the UE cannot complete the current round of global model aggregations, but can complete the current round and the next round of intermediate aggregations of the intermediate node #i. Therefore, the handover is not performed until tₜᵣₐᵢₙ lapses.

In some embodiments of the disclosure, in the case of Tₛₑᵣᵥₑ<T₁, the global node may estimate an increased remaining service time

$${T}_{serve}^{′}$$

assuming one or more of the following operations are performed: increasing a transmit power of one or more of the UE #l, the intermediate node #i and the global node; allocating more transmission resources to either or both of the UE #l and the intermediate node #i; and reducing a RSRP threshold of one or more of UE #l, the intermediate node #i, and the global node. If

$${T}_{serve}^{′} > {T}_{1} ,$$

the global node performs the one or more operations and instructs the UE #l to perform handover after the global aggregation is over.

FIG. 6D illustrates a case of t₁<Tₛₑᵣᵥₑ<tₜᵣₐᵢₙ when the UE #l is a local UE. In this case, the service provided by the original intermediate node #i to the UE may participate in and complete the current round of the intermediate aggregations of the intermediate node #i, but its service time cannot support the completion of the next round of intermediate aggregations of the intermediate node #i. Therefore, the handover is performed after the current round of intermediate aggregations of the intermediate node #i is over. The intermediate node #i transmits the intermediate model after the current round of intermediate aggregations to the UE served by it. At this moment, the UE has the same model as the intermediate node #i. If the UE is handed over to an intermediate node #j and no user is served by the intermediate node #j, the intermediate node #i needs to transmit the intermediate model to the intermediate node #j. If the UE is handed over to be directly served by the global node, the UE directly uploads the local model to the global node for global aggregation after completing k₁k₂ local iterations.

FIG. 6E illustrates the case of Tₛₑᵣᵥₑ<t₁ when the UE #l is a local UE. In this case, the service provided by the original intermediate node #i to the UE #l cannot support the completion of the current round of intermediate aggregations of the intermediate node #i. Therefore, the handover is directly performed. If the UE #l is handed over to an intermediate node #j and no user is served by the intermediate node #j, the intermediate node #i needs to transmit the intermediate model to the intermediate node #j. If the UE is handed over to be directly served by the global node, the UE directly uploads the local model to the global node for global aggregation after completing k₁k₂ local iterations.

In some embodiments of the present disclosure, in the case of Tₛₑᵣᵥₑ<t₁, the global node may estimate an increased remaining service time

$${T}_{serve}^{′} > {T}_{1} ,$$

assuming one or more of the following operations are performed: increasing a transmit power of one or more of the UE #l, the intermediate node #i and the global node; allocating more transmission resources to either or both of the UE #l and the intermediate node #i; and decreasing a RSRP threshold of one or more of the UE #l, the intermediate node #i, and the global node. If

$${T}_{serve}^{′}$$

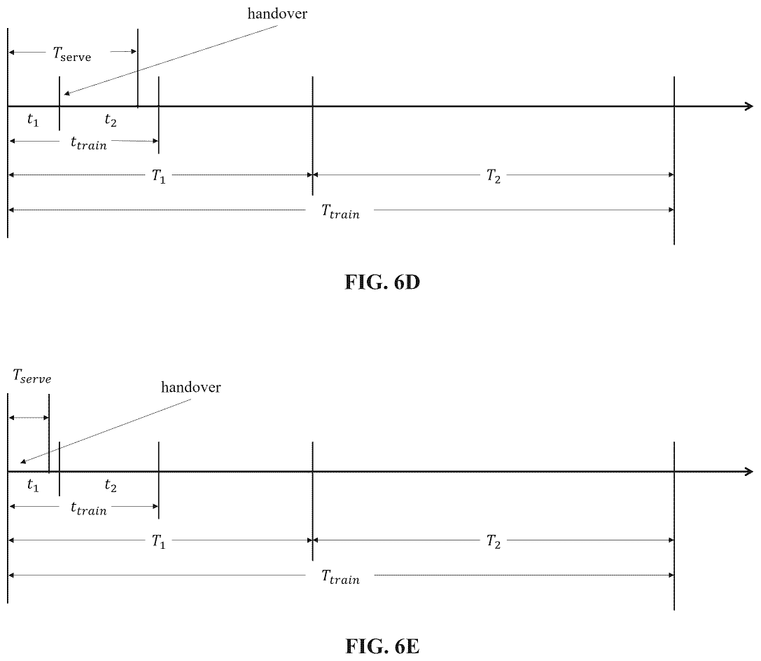

the global node performs the one or more operations and instructs the UE #l to perform handover after the current intermediate aggregation is over. Next, a case where the UE #l is a global UE directly served by the global node will be discussed, and the UE #l may be handed over to be served by an intermediate node #j. FIG. 7 illustrates a handover flow for the global UE according to an embodiment of the present disclosure.

In step S791, the UE #l transmits its own state information Info_{U} to the global node. In step S792, the global node determines a remaining service time Tₛₑᵣᵥₑ for the UE #l, and Tₛₑᵣᵥₑ is the remaining time for which the global node provides service to the UE #l. In step S794, the global node makes a handover decision in a case where a predefined condition is met.

For the estimation of Tₛₑᵣᵥₑ, it can be determined by the global node from the state information Info_{U} of the UE #l. The global node may estimate the link quality and connection time (e.g., the time when RSRP is greater than a certain threshold) between itself and the UE #l, and thus estimate the time Tₛₑᵣᵥₑ for which the global node can serve the UE #l. For example, the global node may determine a time when the link between the global node and UE #l satisfies a corresponding requirement as the time Tₛₑᵣᵥₑ for which the global node may serve the UE #l.

For the estimations of T₁, T₂, and Tₜᵣₐᵢₙ, they may be determined by the global node from the state information Info_{U} of all UEs and the state information Info_{V} of all intermediate nodes. For the estimations of Tₛₑᵣᵥₑ, T₁, T₂, and Tₜᵣₐᵢₙ, they may be performed by the global node periodically, or may be triggered by some trigger event, such as a sudden movement of a UE.

In step S796, the global node transmits the handover decision directly to the UE #l. In step S798, the UE #l performs handover based on the received handover decision.

After making the handover decision, the global node may transmit the handover decision immediately, or in broadcasting the global model after the global aggregation is over. The transmission of the handover decision may be directly to the UE #l through a Uu link (Downlink). The global model is transmitted by broadcast, and can be received by each of the intermediate nodes and the global UEs. However, the handover decision of the global node is not in the form of broadcast, but is transmitted to only the UE #l that needs to perform handover.

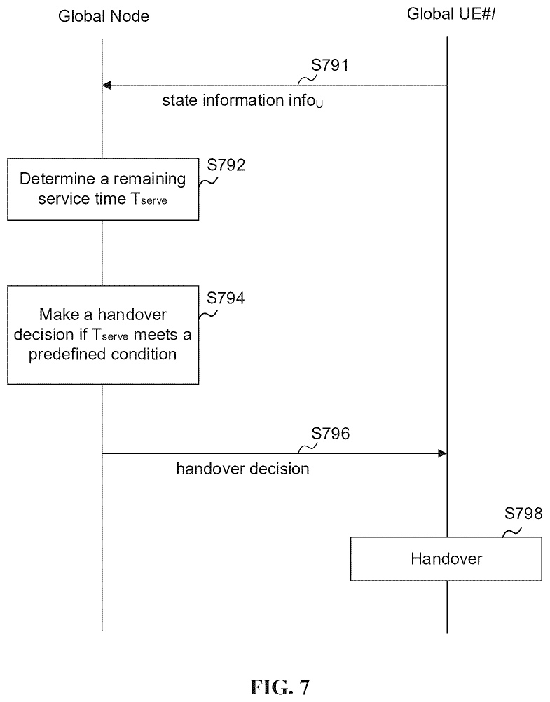

Next, conditions to be met by Tₛₑᵣᵥₑ when the UE #l is a global UE, and whether a handover decision is made under respective conditions, will be discussed with reference to FIGS. 8A-8C, respectively.

FIG. 8A illustrates the case of Tₛₑᵣᵥₑ>Tₜᵣₐᵢₙ when the UE #l is a global UE. In this case, the UE #l may participate in and complete the current round and the next round of global aggregations. Therefore, the handover is not performed until Tₜᵣₐᵢₙ lapses.

FIG. 8B illustrates the case of T₁<Tₛₑᵣᵥₑ<Tₜᵣₐᵢₙ when the UE #l is a global UE. In this case, the UE #l may participate in and complete the current round of global aggregations, but its service time cannot support the completion of the next round of global aggregations, and then the handover is performed after the current round of global aggregation. The global node transmits the global model after the current round of global aggregations by broadcast. At this moment, the UE #l and the intermediate node have the same model, and the handover only needs to consider establishment and release of the communication link, with no need to consider transfer of the model, divergence of the intermediate model, or the like.

FIG. 8C illustrates the case of Tₛₑᵣᵥₑ<T₁ when the UE #l is a global UE. In this case, the service provided by the global node to the UE #l cannot support completion of the current round of global aggregations. Therefore, the handover is directly performed.

In some embodiments of the present disclosure, in the case of Tₛₑᵣᵥₑ<T₁, the global node may estimate an increased remaining service time

$${T}_{serve}^{′} > {t}_{1} ,$$

assuming one or more of the following operations are performed: increasing a transmit power of either or both of the UE #l and the global node; allocating more transmission resources to the UE #l; and reducing a RSRP threshold of either or both of the UE #l and the global node. If

$${T}_{serve}^{′}$$

the global node performs the one or more operations and instructs the UE #l to perform handover after the global aggregation is over.

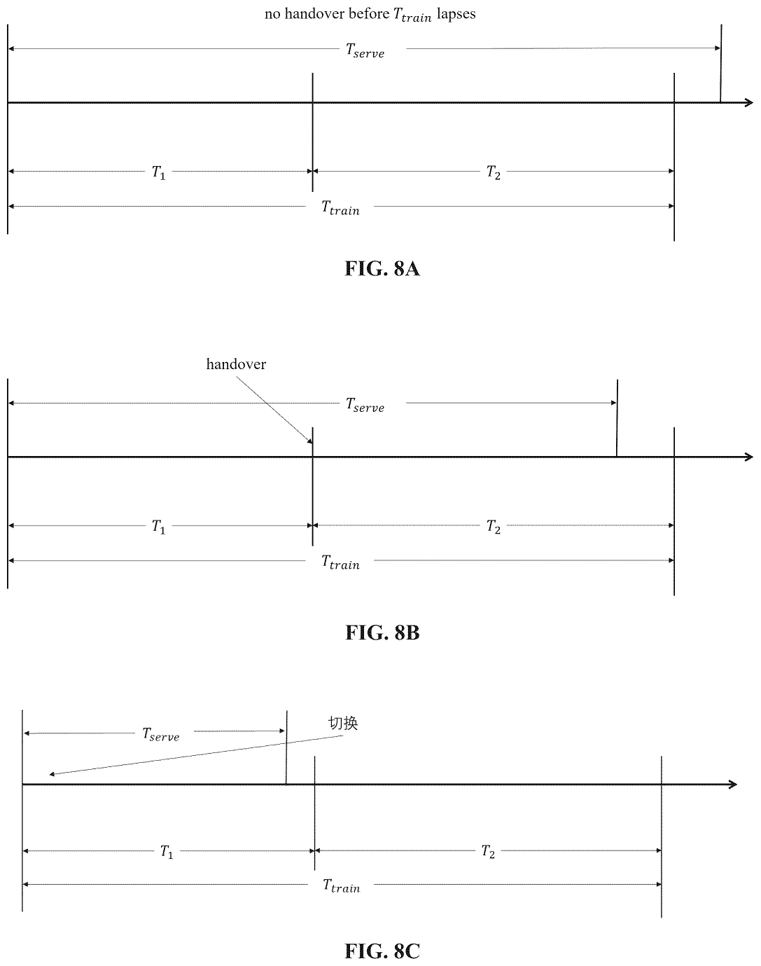

The embodiments of the present disclosure may be applied to a 5G core network. FIG. 9 illustrates a 5G core network SBA (Service-based Architecture) Architecture and a part of Network Functions (NF) thereof.

AF (Application Function) refers to various services in the Application layer, and may be an application inside an operator, or an AF of a third party (e.g., a video server or a game server).

NEF (Network Exposure Function) is located between the 5G core Network and an external third-party application function, and is responsible for managing exposure of network data to outside. All external applications must access internal data of the 5G core network through the NEF.

NWDAF (Network Data Analytics Function) may collect data, perform analytics, and provide analytic results to another Network function, such as the NEF.

AMF (Access and Mobility Management Function) is responsible for registration, connection, reachability, mobility, and security and access management and service authorization.

PCF (Policy Control function) provides all policies related to mobility, UE access selection and PDF session in its charge.

The NWDAF may analyze movement of an intermediate node and time for handover to provide information to the AF, for the AF to calculate optimal federated learning time information, and send the time information to the AMF to affect the mobility management of the UE for efficient federated learning. For example, the NWDAF may estimate Tₛₑᵣᵥₑ, T₁, T₂, Tₜᵣₐᵢₙ, t₁, t₂, and tₜᵣₐᵢₙ, and output estimates to the AF, or output relevant information to the AF for estimation by the AF.

In addition, the AF may also send the handover rules of the embodiments of the present disclosure to the PCF, which sends mobility management policies to the AMF to control the handover for the UE. For example, the AF sends a rule to the PCF that a connection between the UE and the intermediate node should be maintained to the greatest extent when the global aggregation or intermediate aggregation has not been completed, and the PCF further sends policies such as allocating more transmission resources, increasing the transmit power, decreasing the RSRP threshold, or reducing the transmission rate to the AMF.

In addition, the AF may also obtain handover information of the UE through the NEF, so as to control the gNB and the federated learning application in the cloud.

### APPLICATION EXAMPLE

The techniques of the present disclosure can be applied to various products. The base station may be implemented as any type of evolved Node B (eNB), gNB or TRP (Transmit Receive Point), such as macro eNB/gNB and small eNB/gNB. A small eNB/gNB may be an eNB/gNB covering a cell smaller than a macro cell, such as pico eNB/gNB, micro eNB/gNB, and home (femto) eNB/gNB. Alternatively, the base station may be implemented as any other types of base station, such as a NodeB and a base transceiver station (BTS). The base station may include a main body (also known as a base station device) configured to control wireless communication; and one or more remote radio heads (RRH) arranged in a place different from the main body. In addition, the various types of terminals described below may operate as the base stations by temporarily or semi-persistently performing functions of the base station.

The user equipment may be implemented as a mobile terminal (such as a smart phone, a tablet personal computer (PC), a notebook PC, a portable game terminal, a portable/encrypted dog mobile router and a digital camera device) or a vehicle terminal (such as a car navigation device). The user equipment may also be implemented as a terminal that performs machine-to-machine (M2M) communication (also known as a machine type communication (MTC) terminal).

Moreover, the base station and the user equipment each may be implemented as various types of computing devices.

### APPLICATION EXAMPLES OF COMPUTING DEVICE

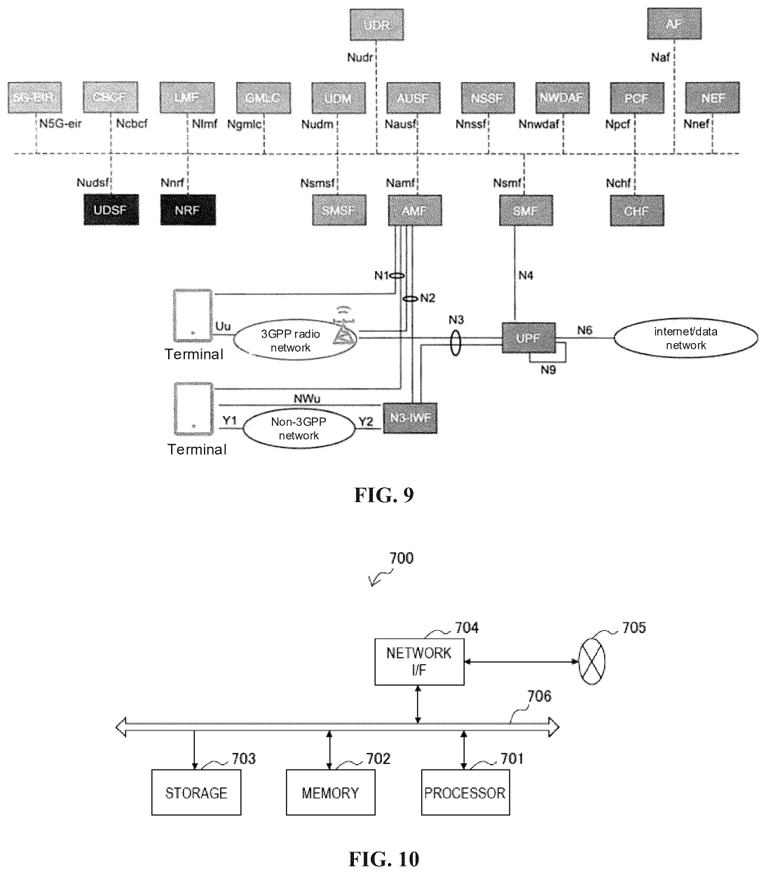

FIG. 10 is a block diagram showing an example of a schematic configuration of a computing device 700 to which the techniques of the present disclosure may be applied. The computing device 700 includes a processor 701, a memory 702, a storage device 703, a network interface 704, and a bus 706.

The processor 701 may be, for example, the central processing unit (CPU) or the digital signal processor (DSP), and control the functions of the server 700. The memory 702 includes a random access memory (RAM) and a read-only memory (ROM), and stores data and programs executed by the processor 701. The storage device 703 may include a storage medium such as a semiconductor memory and a hard disk.

The network interface 704 is a wired communication interface for connecting the server 700 to the wired communication network 705. The wired communication network 705 may be a core network such as an evolved packet core network (EPC) or a packet data network (PDN) such as the Internet.

Bus 706 connects the processor 701, the memory 702, the storage device 703 and the network interface 704 to each other. Bus 706 may include two or more buses each having a different speed (such as a high-speed bus and a low-speed bus).

### APPLICATION EXAMPLES OF BASE STATION

### First Application Example

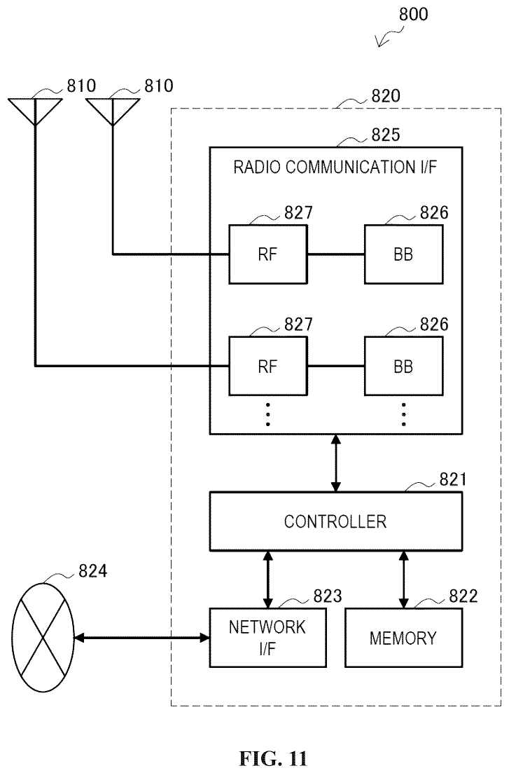

FIG. 11 is a block diagram illustrating a first example of a schematic configuration of the gNB to which the techniques of the present application may be applied. The gNB 800 includes a plurality of antennas 810 and a base station device 820. The base station device 820 and each antenna 810 may be connected with each other via a RF cable.

Each of the antennas 810 includes a single or multiple antenna elements (such as multiple antenna elements included in a Multiple Input and Multiple Output (MIMO) antennas), and is used for the base station 820 to transmit and receive radio signals. The gNB 800 may include multiple antennas 810, as illustrated in FIG. 11. For example, the multiple antennas 810 may be compatible with multiple frequency bands used by the gNB 800. Although FIG. 11 illustrates an example in which the gNB 800 includes multiple antennas 810, the gNB 800 may also include a single antenna 810.

The base station device 820 includes a controller 821, a memory 822, a network interface 823, and a radio communication interface 825.

The controller 821 may be, for example, a CPU or a DSP, and operates various functions of a higher layer of the base station device 820. For example, the controller 821 generates a data packet from data in signals processed by the radio communication interface 825, and transfers the generated packet via the network interface 823. The controller 821 may bundle data from multiple base band processors to generate the bundled packet, and transfer the generated bundled packet. The controller 821 may have logical functions of performing control such as radio resource control, radio bearer control, mobility management, admission control, and scheduling. The control may be performed in corporation with an gNB or a core network node in the vicinity. The memory 822 includes RAM and ROM, and stores a program that is executed by the controller 821, and various types of control data such as a terminal list, transmission power data, and scheduling data.

The network interface 823 is a communication interface for connecting the base station device 820 to a core network 824. The controller 821 may communicate with a core network node or another gNB via the network interface 823. In that case, the gNB 800, and the core network node or the other gNB may be connected to each other through a logical interface such as an S1 interface and an X2 interface. The network interface 823 may also be a wired communication interface or a radio communication interface for radio backhaul. If the network interface 823 is a radio communication interface, the network interface 823 may use a higher frequency band for radio communication than a frequency band used by the radio communication interface 825.

The radio communication interface 825 supports any cellular communication scheme such as Long Term Evolution (LTE) or LTE-Advanced, and provides radio connection to a terminal positioned in a cell of the gNB 800 via the antenna 810. The radio communication interface 825 may typically include, for example, a baseband (BB) processor 826 and an RF circuit 827. The BB processor 826 may perform, for example, encoding/decoding, modulating/demodulating, and multiplexing/demultiplexing, and performs various types of signal processing of layers such as L1, medium access control (MAC), radio link control (RLC), and a packet data convergence protocol (PDCP). The BB processor 826 may have a part or all of the above-described logical functions instead of the controller 821. The BB processor 826 may be a memory that stores a communication control program, or a module that includes a processor configured to execute the program and a related circuit. Updating the program may allow the functions of the BB processor 826 to be changed. The module may be a card or a blade that is inserted into a slot of the base station device 820. Alternatively, the module may also be a chip that is mounted on the card or the blade. Meanwhile, the RF circuit 827 may include, for example, a mixer, a filter, and an amplifier, and transmits and receives radio signals via the antenna 810.

The radio communication interface 825 may include the multiple BB processors 826, as illustrated in FIG. 11. For example, the multiple BB processors 826 may be compatible with multiple frequency bands used by the gNB 800. The radio communication interface 825 may include the multiple RF circuits 827, as illustrated in FIG. 11. For example, the multiple RF circuits 827 may be compatible with multiple antenna elements. Although FIG. 11 illustrates an example in which the radio communication interface 825 includes the multiple BB processors 826 and the multiple RF circuits 827, the radio communication interface 825 may also include a single BB processor 826 or a single RF circuit 827.

### Second Application Example

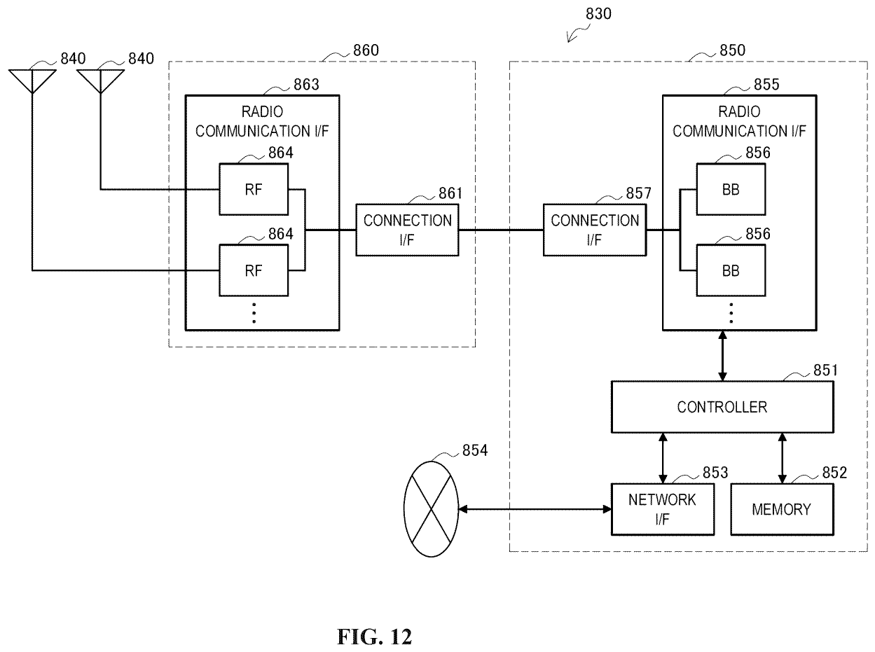

FIG. 12 is a block diagram illustrating a second example of a schematic configuration of the gNB to which the techniques of the present disclosure may be applied. The gNB 830 includes one or more antennas 840, a base station device 850, and an RRH 860. Each antenna 840 and the RRH 860 may be connected to each other via an RF cable. The base station device 850 and the RRH 860 may be connected to each other via a high speed line such as an optical fiber cable.

Each of the antennas 840 includes a single or multiple antenna elements, such as multiple antenna elements included in an MIMO antenna, and is used for the RRH 860 to transmit and receive radio signals. The gNB 830 may include multiple antennas 840, as illustrated in FIG. 12. For example, multiple antennas 840 may be compatible with multiple frequency bands used by the gNB 830. Although FIG. 12 illustrates an example in which the gNB 830 includes multiple antennas 840, the gNB 830 may also include a single antenna 840.

The base station device 850 includes a controller 851, a memory 852, a network interface 853, a radio communication interface 855, and a connection interface 857. The controller 851, the memory 852, and the network interface 853 are the same as the controller 821, the memory 822, and the network interface 823 described with reference to FIG. 11.

The radio communication interface 855 supports any cellular communication scheme such as LTE or LTE-Advanced, and provides radio communication to a terminal positioned in a sector corresponding to the RRH 860 via the RRH 860 and the antenna 840. The radio communication interface 855 may typically include, for example, a BB processor 856. The BB processor 856 is the same as the BB processor 826 described with reference to FIG. 11, except the BB processor 856 is connected to the RF circuit 864 of the RRH 860 via the connection interface 857. The radio communication interface 855 may include the multiple BB processors 856, as illustrated in FIG. 12. For example, multiple BB processors 856 may be compatible with multiple frequency bands used by the gNB 830. Although FIG. 12 illustrates the example in which the radio communication interface 855 includes multiple BB processors 856, the radio communication interface 855 may also include a single BB processor 856.

The connection interface 857 is an interface for connecting the base station device 850 (radio communication interface 855) to the RRH 860. The connection interface 857 may also be a communication module for communication in the above-described high speed line that connects the base station device 850 (radio communication interface 855) to the RRH 860.

The RRH 860 includes a connection interface 861 and a radio communication interface 863.

The connection interface 861 is an interface for connecting the RRH 860 (radio communication interface 863) to the base station device 850. The connection interface 861 may also be a communication module for communication in the above-described high speed line.

The radio communication interface 863 transmits and receives radio signals via the antenna 840. The radio communication interface 863 may typically include, for example, the RF circuit 864. The RF circuit 864 may include, for example, a mixer, a filter, and an amplifier, and transmits and receives radio signals via the antenna 840. The radio communication interface 863 may include multiple RF circuits 864, as illustrated in FIG. 12. For example, multiple RF circuits 864 may support multiple antenna elements. Although FIG. 12 illustrates the example in which the radio communication interface 863 includes the multiple RF circuits 864, the radio communication interface 863 may also include a single RF circuit 864.

### APPLICATION EXAMPLES OF TERMINAL

### First Application Example

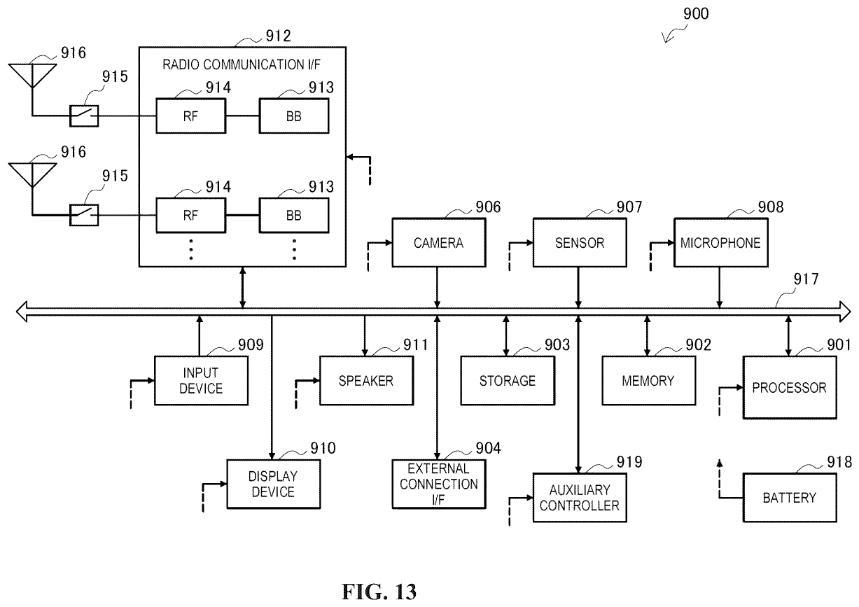

FIG. 13 is a block diagram illustrating an example of a schematic configuration of a smartphone 900 to which the techniques of the present disclosure may be applied. The smartphone 900 includes a processor 901, a memory 902, a storage 903, an external connection interface 904, a camera 906, a sensor 907, a microphone 908, an input device 909, a display device 910, a speaker 911, a radio communication interface 912, one or more antenna switches 915, one or more antennas 916, a bus 917, a battery 918, and an auxiliary controller 919.

The processor 901 may be, for example, a CPU or a system on a chip (SoC), and controls functions of an application layer and the other layers of the smartphone 900. The memory 902 includes RAM and ROM, and stores a program that is executed by the processor 901, and data. The storage 903 may include a storage medium such as a semiconductor memory and a hard disk. The external connection interface 904 is an interface for connecting an external device such as a memory card and a universal serial bus (USB) device to the smartphone 900.

The camera 906 includes an image sensor such as a charge coupled device (CCD) and a complementary metal oxide semiconductor (CMOS), and generates a captured image. The sensor 907 may include a group of sensors such as a measurement sensor, a gyro sensor, a geomagnetic sensor, and an acceleration sensor. The microphone 908 converts the sounds that are input to the smartphone 900 to audio signals. The input device 909 includes, for example, a touch sensor configured to detect touch onto a screen of the display device 910, a keypad, a keyboard, a button, or a switch, and receives an operation or an information input from a user. The display device 910 includes a screen such as a liquid crystal display (LCD) and an organic light-emitting diode (OLED) display, and displays an output image of the smartphone 900. The speaker 911 converts audio signals that are output from the smartphone 900 to sounds.

The radio communication interface 912 supports any cellular communication scheme, such as LTE or LTE-Advanced, and performs radio communication. The radio communication interface 912 may typically include, for example, a BB processor 913 and an RF circuit 914. The BB processor 913 may perform, for example, encoding/decoding, modulating/demodulating, and multiplexing/demultiplexing, and performs various types of signal processing for radio communication. Meanwhile, the RF circuit 914 may include, for example, a mixer, a filter, and an amplifier, and transmits and receives radio signals via the antenna 916. The radio communication interface 912 may also be a one chip module that integrates the BB processor 913 and the RF circuit 914 thereon. The radio communication interface 912 may include multiple BB processors 913 and multiple RF circuits 914, as illustrated in FIG. 13. Although FIG. 13 illustrates the example in which the radio communication interface 912 includes multiple BB processors 913 and multiple RF circuits 914, the radio communication interface 912 may also include a single BB processor 913 or a single RF circuit 914.

Furthermore, in addition to a cellular communication scheme, the radio communication interface 912 may support another type of radio communication scheme such as a short-distance wireless communication scheme, a near field communication scheme, and a wireless local area network (LAN) scheme. In that case, the radio communication interface 912 may include the BB processor 913 and the RF circuit 914 for each radio communication scheme.

Each of the antenna switches 915 switches connection destinations of the antennas 916 among multiple circuits (such as circuits for different radio communication schemes) included in the radio communication interface 912.

Each of the antennas 916 includes a single or multiple antenna elements, such as multiple antenna elements included in an MIMO antenna, and is used for the radio communication interface 912 to transmit and receive radio signals. The smartphone 900 may include multiple antennas 916, as illustrated in FIG. 13. Although FIG. 13 illustrates the example in which the smartphone 900 includes multiple antennas 916, the smartphone 900 may also include a single antenna 916.

Furthermore, the smartphone 900 may include the antenna 916 for each radio communication scheme. In that case, the antenna switches 915 may be omitted from the configuration of the smartphone 900.

The bus 917 connects the processor 901, the memory 902, the storage 903, the external connection interface 904, the camera 906, the sensor 907, the microphone 908, the input device 909, the display device 910, the speaker 911, the radio communication interface 912, and the auxiliary controller 919 to each other. The battery 918 supplies power to blocks of the smartphone 900 illustrated in FIG. 13 via feeder lines, which are partially shown as dashed lines in the figure. The auxiliary controller 919 operates a minimum necessary function of the smartphone 900, for example, in a sleep mode.

### Second Application Example

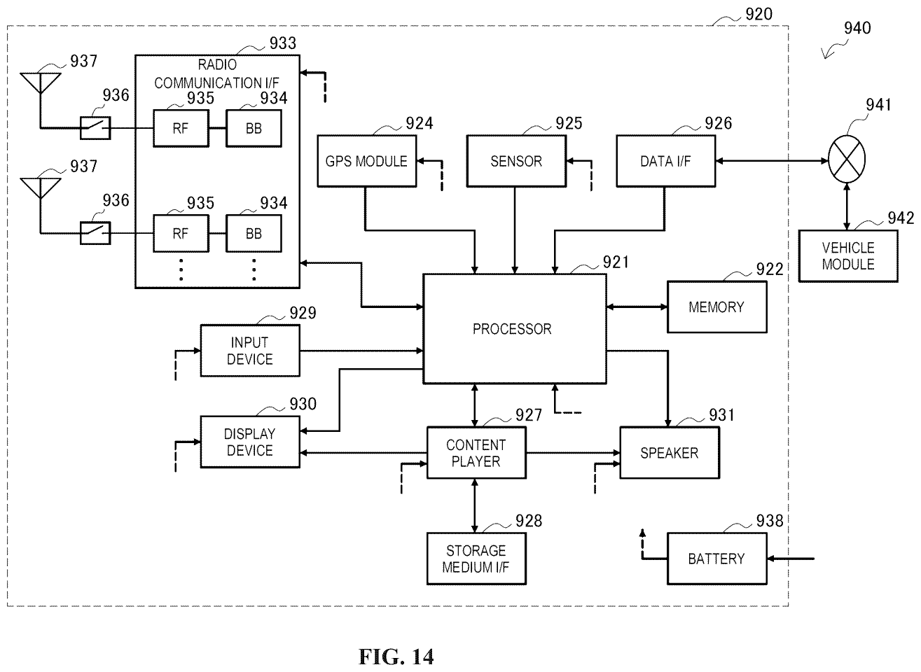

FIG. 14 is a block diagram illustrating an example of a schematic configuration of a car navigation device 920 to which the techniques of the present disclosure may be applied. The car navigation device 920 includes a processor 921, a memory 922, a global positioning system (GPS) module 924, a sensor 925, a data interface 926, a content player 927, a storage medium interface 928, an input device 929, a display device 930, a speaker 931, a radio communication interface 933, one or more antenna switches 936, one or more antennas 937, and a battery 938.

The processor 921 may be, for example, a CPU or a SoC, and controls a navigation function and other functions of the car navigation device 920. The memory 922 includes RAM and ROM, and stores a program that is executed by the processor 921, and data.

The GPS module 924 uses GPS signals received from a GPS satellite to measure a position, such as latitude, longitude, and altitude, of the car navigation device 920. The sensor 925 may include a group of sensors such as a gyro sensor, a geomagnetic sensor, and an air pressure sensor. The data interface 926 is connected to, for example, an in-vehicle network 941 via a terminal that is not shown, and acquires data generated by the vehicle, such as vehicle speed data.

The content player 927 reproduces content stored in a storage medium, such as a CD and a DVD, that is inserted into the storage medium interface 928. The input device 929 includes, for example, a touch sensor configured to detect touch onto a screen of the display device 930, a button, or a switch, and receives an operation or an information input from a user. The display device 930 includes a screen such as a LCD or an OLED display, and displays an image of the navigation function or content that is reproduced. The speaker 931 outputs sounds of the navigation function or the content that is reproduced.

The radio communication interface 933 supports any cellular communication scheme, such as LTE or LTE-A, and performs radio communication. The radio communication interface 933 may typically include, for example, a BB processor 934 and an RF circuit 935. The BB processor 934 may perform, for example, encoding/decoding, modulating/demodulating, and multiplexing/demultiplexing, and performs various types of signal processing for radio communication. Meanwhile, the RF circuit 935 may include, for example, a mixer, a filter, and an amplifier, and transmits and receives radio signals via the antenna 937. The radio communication interface 933 may be a one chip module which integrates the BB processor 934 and the RF circuit 935 thereon. The radio communication interface 933 may include multiple BB processors 934 and multiple RF circuits 935, as illustrated in FIG. 14. Although FIG. 14 illustrates the example in which the radio communication interface 933 includes multiple BB processors 934 and multiple RF circuits 935, the radio communication interface 933 may also include a single BB processor 934 or a single RF circuit 935.

Furthermore, in addition to a cellular communication scheme, the radio communication interface 933 may support another type of radio communication scheme such as a short-distance wireless communication scheme, a near field communication scheme, and a wireless LAN scheme. In that case, the radio communication interface 933 may include the BB processor 934 and the RF circuit 935 for each radio communication scheme.

Each of the antenna switches 936 switches connection destinations of the antennas 937 among multiple circuits (such as circuits for different radio communication schemes) included in the radio communication interface 933.

Each of the antennas 937 includes a single or multiple antenna elements, such as multiple antenna elements included in an MIMO antenna, and is used for the radio communication interface 933 to transmit and receive radio signals. The car navigation device 920 may include the multiple antennas 937, as illustrated in FIG. 14. Although FIG. 14 illustrates the example in which the car navigation device 920 includes multiple antennas 937, the car navigation device 920 may also include a single antenna 937.

Furthermore, the car navigation device 920 may include the antenna 937 for each radio communication scheme. In that case, the antenna switches 936 may be omitted from the configuration of the car navigation device 920.

The battery 938 supplies power to blocks of the car navigation device 920 illustrated in FIG. 14 via feeder lines that are partially shown as dashed lines in the figure. The battery 938 accumulates power supplied from the vehicle.

The techniques of the present disclosure may also be realized as an in-vehicle system (or a vehicle) 940 including one or more blocks of the car navigation device 920, the in-vehicle network 941, and a vehicle module 942. The vehicle module 942 generates vehicle data such as vehicle speed, engine speed, and trouble information, and outputs the generated data to the in-vehicle network 941.

Various schematic blocks and components described in the present disclosure may be implemented or executed with general-purpose processors, digital signal processors (DSP), ASIC, FPGA or other programmable logic devices, discrete gate or transistor logic, discrete hardware components or any combination of them designed to perform the functions described herein. The general-purpose processor may be a microprocessor, but alternatively, the processor may be any conventional processor, controller, microcontroller and/or state machine. Processors may also be implemented as combinations of computing devices, such as DSP and microprocessors, multiple microprocessors, one or more microprocessors combined with DSP cores, and/or any other such configuration.

The functions described herein can be implemented in hardware, software executed by the processor, firmware, or any combination of them. If implemented in software executed by the processor, the function may be stored on a non-transient computer-readable medium or transmitted as one or more instructions or codes on a non-transient computer-readable medium. Other examples and implementations are within the scope and spirit of the present disclosure and the accompanying claims. For example, given the nature of the software, the functions described above may be performed using software, hardware, firmware, hard wiring, or any combination of these performed by the processor. Features that implement the function can also be physically placed in various locations, including being distributed so that parts of the function are implemented in different physical locations.

In addition, the disclosure of components contained in or separated from other components should be considered exemplary because a variety of other architectures can potentially be implemented to achieve the same function, including the integration of all, most, and/or some components as part of one or more single or separate structures.

The non-transient computer-readable medium may be any available non-transient medium that can be accessed by a general-purpose computer or a dedicated computer. For example, without limitation, non-transient computer-readable media may include RAM, ROM, EEPROM, flash memory, CD-ROM, DVD or other optical disc storage, disk storage or other magnetic storage devices, or desired program code components that can be used to carry or store instructions or data structures and any other media that can be accessed by general-purpose or dedicated computers or general-purpose or dedicated processors.

The previous descriptions of the present disclosure are provided to enable those skilled in the art to produce or use the present disclosure. The various modifications to the present disclosure are obvious to those skilled in the art, and the general principles defined herein can be applied to other variants without departing from the scope of this disclosure. Therefore, the present disclosure is not limited to the examples and designs described herein, but corresponds to the widest range consistent with the disclosed principles and new features.

The present disclosure further includes the following implementations.
1. An electronic device for federated learning at a network, comprising processing circuitry configured to:
determine a model aggregation time and a remaining service time Tₛₑᵣᵥₑ for a user equipment, wherein the user equipment is directly connected to the network or indirectly connected to the network via an intermediate node;
make a handover decision for the user equipment in a case where the model aggregation time and the remaining service time Tₛₑᵣᵥₑ meet a predefined condition; and transmit the handover decision for the user equipment.
2. The electronic device of Implementation 1, wherein the processing circuitry is further configured to:
receive an intermediate aggregation model from the intermediate node;
generate a global aggregation model based on at least the intermediate aggregation model; and
broadcast the global aggregation model.
3. The electronic device of Implementation 1, wherein the processing circuitry is further configured to receive state information of the user equipment, and the model aggregation time and the remaining service time Tₛₑᵣᵥₑ are determined based on at least the state information of the user equipment.
4. The electronic device of Implementation 3, wherein the state information of the user equipment includes one or more of channel state, computing capability, local data information, power, location or movement information.
5. The electronic device of Implementation 3, wherein the processing circuitry is further configured to receive state information of the intermediate node, and the model aggregation time and the remaining service time Tₛₑᵣᵥₑ are determined further based on the state information of the intermediate node.
6. The electronic device of Implementation 5, wherein the state information of the intermediate node includes one or more of channel state, computing capability, location or movement information.
7. The electronic device of Implementation 1, wherein
the model aggregation time includes a remaining time T₁ required for a current global aggregation and a time T₂ required for a next global aggregation, and
the handover decision for the user equipment is made if T₁<Tₛₑᵣᵥₑ<T₁+T₂, and the handover decision instructs the user equipment to perform handover after the current global aggregation is over.
8. The electronic device of Implementation 7, wherein if Tₛₑᵣᵥₑ<T₁, the processing circuitry is further configured to estimate an increased remaining service time

$${T}_{serve}^{′} > {T}_{1} ,$$

assuming in at one or more of the following operations are performed:
increasing a transmit power of one or more of the user equipment, the intermediate node or a global node;
allocating more transmission resources to either or both of the user equipment and the intermediate node; and
reducing a RSRP threshold of one or more of the user equipment, the intermediate node or the global node, and
perform the one or more operations and make the handover decision for the user equipment if

$${T}_{serve}^{′}$$

the handover decision instructing the user equipment to perform handover after the current global aggregation is over.
9. The electronic device of Implementation 1 or 7, wherein the model aggregation time includes a remaining time t₁ required for a current intermediate aggregation and a time t₂ required for a next intermediate aggregation at the intermediate node, and
the handover decision for the user equipment is made if t₁<Tₛₑᵣᵥₑ<t₁+t₂, and the handover decision instructs the user equipment to perform handover after the current intermediate aggregation is over.
10. The electronic device of Implementation 9, wherein the handover decision for the user equipment is made if Tₛₑᵣᵥₑ<t₁, and the handover decision instructs the user equipment to perform handover immediately.
11. The electronic device of Implementation 9, wherein if Tₛₑᵣᵥₑ<t₁, the processing circuitry is further configured to estimate an increased remaining service time

$${T}_{serve}^{′} > {T}_{1} ,$$

assuming wat one or more of the following operations are performed:
increasing a transmit power of one or more of the user equipment, the intermediate node or a global node;
allocating more transmission resources to either or both of the user equipment and the intermediate node; and
reducing a RSRP threshold of one or more of the user equipment, the intermediate node or the global node, and
perform the one or more operations and make the handover decision for the user equipment if

$${T}_{serve}^{′}$$

the handover decision instructing the user equipment to perform handover after the current intermediate aggregation is over.
12. The electronic device of Implementation 9, wherein if the user equipment is handed over to another intermediate node and there is no intermediate aggregation model at the another intermediate node, the intermediate aggregation model at the intermediate node is transmitted to the another intermediate node.
13. An electronic device for federated learning at an intermediate node, comprising processing circuitry configured to:
receive a handover decision for a user equipment from a network, wherein the handover decision is made in a case where a model aggregation time and a remaining service time Tₛₑᵣᵥₑ for the user equipment meet a predefined condition, and the user equipment is indirectly connected to the network via the intermediate node; and
transmit the handover decision to the user equipment.
14. The electronic device of Implementation 13, wherein the processing circuitry is further configured to:
receive a local model from the use equipment, generate an intermediate aggregation model based on at least the local mode, and transmit the intermediate aggregation model to the network; and
receive a global aggregation model from the network, and transmit the global aggregation model to the user equipment.
15. The electronic device of Implementation 13, wherein the processing circuitry is further configured to:
receive state information of the user equipment; and
transmit the state information of the user equipment and state information of the intermediate node to the network,
wherein the model aggregation time and the remaining service time Tₛₑᵣᵥₑ are determined based on at least the state information of the user equipment and the state information of the intermediate node.
16. The electronic device of Implementation 13, wherein the processing circuitry is further configured to:
receive state information of the user equipment; and
determine at least a portion of the model aggregation time based on at least the state information of the user equipment and state information of the intermediate node;
transmit the state information of the user equipment, the state information of the intermediate node and at least the portion of the model aggregation time to the network;
wherein the rest of the model aggregation time and the remaining service time Tₛₑᵣᵥₑ are determined based on at least the state information of the user equipment and the state information of the intermediate node.
17. An electronic device for federated learning at a user equipment, comprising processing circuitry configured to:
receive a handover decision for the user equipment from a network, wherein the handover decision is made in a case where a model aggregation time and a remaining service time Tₛₑᵣᵥₑ for the user equipment meet a predefined condition, and the user equipment is directly connected to the network or indirectly connected to the network via an intermediate node; and perform handover based on the handover decision.
18. The electronic device of Implementation 17, wherein the processing circuitry is further configured to:
train a local model using local data;
transmit the local model to the network or the intermediate node; and
receive a global aggregation model from the network;
update the local model to the global aggregation model.
19. The electronic device of Implementation 17, wherein the processing circuitry is further configured to:
transmit state information of the user equipment to the network or the intermediate node,
wherein the model aggregation time and the remaining service time Tₛₑᵣᵥₑ are determined based on at least the state information of the user equipment.
20. A method for federated learning at a network, comprising:
determining a model aggregation time and a remaining service time Tₛₑᵣᵥₑ for a user equipment, wherein the user equipment is directly connected to the network or indirectly connected to the network via an intermediate node;
making a handover decision for the user equipment in a case where the model aggregation time and the remaining service time Tₛₑᵣᵥₑ meet a predefined condition; and
transmitting the handover decision for the user equipment.
21. A method for federated learning at an intermediate node, comprising:
receiving a handover decision for a user equipment from a network, wherein the handover decision is made in a case where a model aggregation time and a remaining service time Tₛₑᵣᵥₑ for the user equipment meet a predefined condition, and the user equipment is indirectly connected to the network via the intermediate node; and
transmitting the handover decision to the user equipment.
22. A method for federated learning at a user equipment, comprising:
receiving a handover decision for the user equipment from a network, wherein the handover decision is made in a case where a model aggregation time and a remaining service time Tₛₑᵣᵥₑ for the user equipment meet a predefined condition, and the user equipment is directly connected to the network or indirectly connected to the network via an intermediate node; and
performing handover based on the handover decision.
23. A non-transitory computer readable storage medium storing program instructions thereon which, when executed by a processor, cause the processor to perform the method according to any of claims 20 to 22.
24. A computer program product comprising program instructions which, when executed by a processor, cause the processor to perform the method according to any of claims 20 to 22.

1. An electronic device for federated learning at a network, comprising processing circuitry configured to:
determine a model aggregation time and a remaining service time Tₛₑᵣᵥₑ for a user equipment, wherein the user equipment is directly connected to the network or indirectly connected to the network via an intermediate node;
make a handover decision for the user equipment in a case where the model aggregation time and the remaining service time Tₛₑᵣᵥₑ meet a predefined condition; and
transmit the handover decision for the user equipment.

2. The electronic device of claim 1, wherein the processing circuitry is further configured to:
receive an intermediate aggregation model from the intermediate node;
generate a global aggregation model based on at least the intermediate aggregation model; and
broadcast the global aggregation model.

3. The electronic device of claim 1, wherein the processing circuitry is further configured to receive state information of the user equipment, and the model aggregation time and the remaining service time Tₛₑᵣᵥₑ are determined based on at least the state information of the user equipment.

4. The electronic device of claim 3, wherein the state information of the user equipment includes one or more of channel state, computing capability, local data information, power, location or movement information.

5. The electronic device of claim 3, wherein the processing circuitry is further configured to receive state information of the intermediate node, and the model aggregation time and the remaining service time Tₛₑᵣᵥₑ are determined further based on the state information of the intermediate node.

6. The electronic device of claim 5, wherein the state information of the intermediate node includes one or more of channel state, computing capability, location or movement information.

7. The electronic device of claim 1, wherein
the model aggregation time includes a remaining time T₁ required for a current global aggregation and a time T₂ required for a next global aggregation, and
the handover decision for the user equipment is made if T₁<Tₛₑᵣᵥₑ<T₁+T₂, and the handover decision instructs the user equipment to perform handover after the current global aggregation is over.

8. The electronic device of claim 7, wherein if Tₛₑᵣᵥₑ<T₁, the processing circuitry is further configured to estimate an increased remaining service time
$${T}_{serve}^{′}$$
assuming that one or more of the following operations are performed:
increasing a transmit power of one or more of the user equipment, the intermediate node or a global node;
allocating more transmission resources to either or both of the user equipment and the intermediate node; and
reducing a RSRP threshold of one or more of the user equipment, the intermediate node or the global node, and
perform the one or more operations and make the handover decision for the user equipment if
$${T}_{serve}^{′} > {t}_{1} ,$$
the handover decision instructing the user equipment to perform handover after the current global aggregation is over.

9. The electronic device of claim 1, wherein the model aggregation time includes a remaining time t₁ required for a current intermediate aggregation and a time t₂ required for a next intermediate aggregation at the intermediate node, and
the handover decision for the user equipment is made if t₁<Tₛₑᵣᵥₑ<t₁+t₂, and the handover decision instructs the user equipment to perform handover after the current intermediate aggregation is over.

10. The electronic device of claim 9, wherein the handover decision for the user equipment is made if Tₛₑᵣᵥₑ<t₁, and the handover decision instructs the user equipment to perform handover immediately.

11. The electronic device of claim 9, wherein if Tₛₑᵣᵥₑ<t₁, the processing circuitry is further configured to estimate an increased remaining service time
$${T}_{serve}^{′} > {T}_{1} ,$$
assuming that one or more of the following operations are performed:
increasing a transmit power of one or more of the user equipment, the intermediate node or a global node;
allocating more transmission resources to either or both of the user equipment and the intermediate node; and
reducing a RSRP threshold of one or more of the user equipment, the intermediate node or the global node, and
perform the one or more operations and make the handover decision for the user equipment if
$${T}_{serve}^{′}$$
the handover decision instructing the user equipment to perform handover after the current intermediate aggregation is over.

12. The electronic device of claim 9, wherein if the user equipment is handed over to another intermediate node and there is no intermediate aggregation model at the another intermediate node, the intermediate aggregation model at the intermediate node is transmitted to the another intermediate node.

13. An electronic device for federated learning at an intermediate node, comprising processing circuitry configured to:
receive a handover decision for a user equipment from a network, wherein the handover decision is made in a case where a model aggregation time and a remaining service time Tₛₑᵣᵥₑ for the user equipment meet a predefined condition, and the user equipment is indirectly connected to the network via the intermediate node; and
transmit the handover decision to the user equipment.

14. The electronic device of claim 13, wherein the processing circuitry is further configured to:
receive a local model from the use equipment, generate an intermediate aggregation model based on at least the local mode, and transmit the intermediate aggregation model to the network; and
receive a global aggregation model from the network, and transmit the global aggregation model to the user equipment.

15. The electronic device of claim 13, wherein the processing circuitry is further configured to:
receive state information of the user equipment; and
transmit the state information of the user equipment and state information of the intermediate node to the network,
wherein the model aggregation time and the remaining service time Tₛₑᵣᵥₑ are determined based on at least the state information of the user equipment and the state information of the intermediate node.

16. The electronic device of claim 13, wherein the processing circuitry is further configured to:
receive state information of the user equipment; and
determine at least a portion of the model aggregation time based on at least the state information of the user equipment and state information of the intermediate node;
transmit the state information of the user equipment, the state information of the intermediate node and at least the portion of the model aggregation time to the network;
wherein the rest of the model aggregation time and the remaining service time Tₛₑᵣᵥₑ are determined based on at least the state information of the user equipment and the state information of the intermediate node.

17. An electronic device for federated learning at a user equipment, comprising processing circuitry configured to:
receive a handover decision for the user equipment from a network, wherein the handover decision is made in a case where a model aggregation time and a remaining service time Tₛₑᵣᵥₑ for the user equipment meet a predefined condition, and the user equipment is directly connected to the network or indirectly connected to the network via an intermediate node; and
perform handover based on the handover decision.

18. The electronic device of claim 17, wherein the processing circuitry is further configured to:
train a local model using local data;
transmit the local model to the network or the intermediate node; and
receive a global aggregation model from the network;
update the local model to the global aggregation model.

19. The electronic device of claim 17, wherein the processing circuitry is further configured to:
transmit state information of the user equipment to the network or the intermediate node,
wherein the model aggregation time and the remaining service time Tₛₑᵣᵥₑ are determined based on at least the state information of the user equipment.

20.-24. (canceled)
